(19) United States
(12) Patent Application Publication
(10) Pub. No.: US 2025/0245173 A1
(43) Pub. Date: Jul. 31, 2025

(54) SYSTEM AND METHOD FOR MANAGING AND ORCHESTRATING A SEAMLESS USER PERIPHERAL DEVICE WORKSPACE ECOSYSTEM EXPERIENCE

(71) Applicant: Dell Products, LP, Round Rock, TX (US)

(72) Inventors: Shailesh Jain, Thane (IN); Vivek Viswanathan Iyer, Saint Johns, FL (US)

(73) Assignee: Dell Products, LP, Round Rock, TX (US)

(21) Appl. No.: 18/427,551

(22) Filed: Jan. 30, 2024

(51) Int. Cl. G06F 13/10; H04L 67/10

(52) U.S. Cl. CPC G06F 13/105; H04L 67/10

(57) ABSTRACT

A peripheral device workspace cloud orchestrator server includes a network interface device to receive detected peripheral device enrollment data describing peripheral device nodes to be registered with the peripheral device workspace cloud orchestrator server and hardware device operational policies describing how the registered peripheral device nodes are to operate. The hardware processor executes computer code of a cloud manageability orchestrator module to create and store, on a peripheral device workspace database, peripheral device workspaces with each of the peripheral device workspaces having a peripheral device workspace identification value, wherein the peripheral device workspaces are defined by a manifest of detected peripheral device nodes operatively coupled to an anchor node information handling system and a physical location of the anchor node information handling system.

The present disclosure generally relates to automatic managing and configuration of devices and nodes for use in a user workspace. The present disclosure more specifically relates to creating a peripheral device workspace including a plurality of devices and nodes and that may be a plurality of peripheral devices used with one or more smart devices managing, configuring, and updating of those devices and nodes within the formed peripheral device workspace.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more applications such as a gaming application. Further, the information handling system may include a plurality of peripheral devices that are identifiable by a server operatively coupled to the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system operatively coupled to a remotely located peripheral device workspace cloud orchestrator server according to an embodiment of the present disclosure;

FIG. 2 is a graphic diagram of a plurality of peripheral device workspaces formed including a plurality of nodes that may form a defined peripheral device workspace identified at a remotely located peripheral device workspace cloud orchestrator server according to another embodiment of the present disclosure;

FIG. 3 is a graphic diagram of a peripheral device workspace cloud orchestrator server system and an information handling system that may serve as an anchor device node used to manage and orchestrate peripheral device workspaces according to another embodiment of the present disclosure;

FIG. 4 is a flow chart showing a method of an internet technology decision maker (ITDM) ordering a subscription to manage and orchestrate node devices within a peripheral device workspace according to an embodiment of the present disclosure;

FIG. 5 is a flow chart showing a method of executing code instructions for a cloud manageability orchestrator module at a peripheral device workspace cloud orchestrator server automatically creating a peripheral device workspace to manage and orchestrate node devices within the created peripheral device workspace according to an embodiment of the present disclosure;

FIG. 6 is a flow chart showing a method of executing code instructions for a cloud manageability orchestrator module at a peripheral device workspace cloud orchestrator server automatically registering node devices within a peripheral device workspace to manage and orchestrate those node devices according to an embodiment of the present disclosure;

FIG. 7 is a flow chart showing a method of executing code instructions for a cloud manageability orchestrator module at a peripheral device workspace cloud orchestrator server automatically configuring a peripheral device workspace according to an embodiment of the present disclosure;

FIG. 8 is a flow chart showing method of executing code instructions for a cloud manageability orchestrator module at a peripheral device workspace cloud orchestrator server automatically updating a peripheral device workspace by propagating update packages to the node devices within the peripheral device workspace according to an embodiment of the present disclosure; and

FIG. 9 is a flow chart showing method of executing code instructions for a cloud manageability orchestrator module at a peripheral device workspace cloud orchestrator server automatically creating a peripheral device workspaces, updating a peripheral device workspaces, and propagating hardware device operation policies or update packages to the node devices within the peripheral device workspaces according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

A user may oftentimes use an information handling system in a peripheral device workspace. In this context, a peripheral device workspace can be viewed as an environment that includes a user information handling system (e.g., a laptop) as one possible anchor node and one or more peripheral devices also referred to as peripherals as peripheral device workspace nodes that are connected to the user information handling system. In an embodiment, each of the information handling system and peripherals may be referred to as node devices. An environmental context may be determined for a formed peripheral device workspace and may include, for example, physical location, networked location, time of day, applications being executed, wireless or wired connection capabilities, security credentials for a user, user identification, and other factors. Node devices may commonly include, in some embodiments, internal or external devices such as displays, a keyboard, a mouse, a webcam, a printer, a speaker, a fingerprint scanner, a trackpad, and a stylus, among others that may be integrated peripheral devices in a primary information handling system node (e.g., a laptop) or separate, external peripheral device nodes. Oftentimes, a peripheral device workspace may include a wired or wireless dock as at least one example of a smart node by which the user information handling system connects to some or all the secondary, external node devices including other smart node devices having some compute or input/output (networking) capabilities. Such smart devices may operate as backup or replace the user information handling system as an anchor node in the peripheral device workspace in some embodiments herein.

According to embodiments herein, a formed peripheral device workspace may oftentimes be used for hybrid work scenarios. For example, a business may have an office space that includes hoteling cubes that can be assigned to, reserved by, or otherwise utilized by the business' employees as peripheral device workspaces for use with one or more peripheral devices and an information handling system introduced to the peripheral device workspace for the duration it is used by the identified user such as a business' employee. In such an example case, the business may allow its individual employees to connect their laptops to a dock in a particular hoteling cube having a formed peripheral device workspace where various external peripherals may be available for use. Users may also employ other peripheral device workspaces when working from home or other locations and the information handling system and some portion of the external peripheral devices may travel with the user to one or more of the identified peripheral device workspaces that a particular user may enter and use.

When a user employs multiple peripheral device workspaces (e.g., by connecting a laptop to different combinations of peripherals during a workday), it can be tedious for the user to configure any of the other peripheral devices in each of the peripheral device workspaces to his or her preferences. For example, while using one peripheral device workspace, the user may set configurations for the peripherals of the peripheral device workspace to match the user's preferences. If the user switches to a different peripheral device workspace, those configurations may not be consistent with the peripherals of the different peripheral device workspace or may result in unintended changes. This is particularly true of those peripheral device workspaces where a user may share the peripheral device workspace with other users. Additionally, the peripheral device workspaces may serve different purposes for the user or require different settings for one or more nodes in each defined peripheral device workspace. The user may therefore have to manually reconfigure the peripheral device workspace upon entering each new peripheral device workspace.

Still further, changes to the peripheral device workspace may occur when, for example, a node device requires firmware/software updates, old node devices are removed from the peripheral device workspace, new node devices are added to the peripheral device workspace, or changes in the compliance of these node devices relative to hardware device operational policies provided to the node devices from an internet technology decision maker (ITDM) occur. Such ITDM established hardware device operational policies may be set to determine how a node device may perform within the peripheral device workspace in some example embodiments. How the node device may perform within the peripheral device workspace may depend on the environment of the peripheral device workspace, the risks of security any given node device poses within the peripheral device workspace, and what the capabilities or configurations of any given node device are as well as aspects of the user's needs upon entering such a peripheral device workspace.

Execution of computer code instructions of a cloud peripheral device workspace manageability orchestrator module allows an ITDM, via a cloud peripheral device workspace orchestrator console operatively coupled to a cloud peripheral device workspace orchestrator server, to receive device enrollment data describing one or more node devices and to create a peripheral device workspace with the one or more node devices forming part of the peripheral device workspace. This device enrollment data may be received at the cloud peripheral device workspace orchestrator server that also includes a hardware processor capable of receiving device enrollment data and create a peripheral device workspace with the one or more node devices forming part of the peripheral device workspace and store identification, such as an peripheral device workspace identification value of such a defined peripheral device workspaces at a memory location via the peripheral device workspace cloud orchestrator server. Execution of the cloud peripheral device workspace manageability orchestrator module may also cause the hardware processor of the cloud peripheral device workspace orchestrator server to receive hardware device operational policies based on the registered node devices detected within the one or more created peripheral device workspaces in those identified peripheral device workspaces stored in a cloud database. These hardware device operational policies may be received from the ITDM at the could peripheral device workspace orchestrator server that allow the ITDM to define these hardware device operational policies that are used to define the peripheral device workspace based on the detected node devices, environment, and other factors such as assigned user and preferences, requirements, or activity determined for an assigned user.

In an embodiment, the hardware processor of the cloud peripheral device workspace orchestrator server may also execute computer code instructions of an ecosystem manageability service module. Execution of code instructions for the ecosystem manageability service module via the peripheral device workspace cloud orchestrator server causes the hardware device operational policies to be applied to the created peripheral device workspace. In an embodiment, the cloud peripheral device workspace manageability orchestrator module creates hardware device operational policies for each of the one or more node devices within the peripheral device workspace based on received hardware device operational policies created by an ITDM and received at the cloud peripheral device workspace orchestrator server via the cloud peripheral device workspace orchestrator consol.

An ITDM, on behalf of a user of a recently purchased node device, may wish to automatically configure the newly purchased node devices in the same way that similar node devices (e.g., those being replaced by the new or updated node device, for example) were configured, and for various peripheral device workspaces and contexts having peripheral device workspace identification values already associated with that user. Each user may be associated with a composite peripheral device workspace identifier, generated and stored at ecosystem manageability sub-agent of the user's information handling system (e.g., one node device within the peripheral device workspace) and that includes an identification of a single user, a plurality of peripheral device workspaces having peripheral device workspace identification values associated with that user, a plurality of contexts associated with that user, and a plurality of node devices that have been operatively coupled to the user's information handling system, as described in previously received manifests. Upon purchase of a new peripheral device, for example, code instructions of the cloud peripheral device workspace manageability orchestrator module executing in the cloud peripheral device workspace orchestrator server may generate a new composite identifier for the user that includes an identification of the newly purchased node device (e.g., by MAC address for example). As an ITDM purchases node devices for a fleet of users, for example, the lifecycle of the fleet of node devices may be associated with a specific peripheral device workspace having a peripheral device workspace identification value and user having a composite peripheral device workspace identifier as well as be associated with other similar node devices such that propagation of software/firmware updates are easily completed under the direction of the ITDM.

Following setup of the newly purchased node device or node devices, an ITDM, using a cloud peripheral device workspace orchestrator console operatively coupled to the cloud peripheral device workspace orchestrator server, may see changes to the use of each node device as well as changes to settings associated with each node device associated with each user. The ITDM may be presented, via a video display device of the cloud peripheral device workspace orchestrator console, with data describing these setting for each user's device nodes as part of peripheral device workspace identifier and peripheral device workspace identification values for relevant peripheral device workspaces. The ITDM may also determine whether the current settings or even the inclusion of other node devices within the peripheral device workspace is compliant or not compliant with current hardware device operational policies set by the ITDM and passed to each peripheral device workspace and node device via execution of the cloud peripheral device workspace manageability orchestrator module and ecosystem manageability service module as described. Via the cloud peripheral device workspace orchestrator console, an ITDM may determine whether the hardware device operational policies propagated via the execution of the cloud peripheral device workspace manageability orchestrator module and ecosystem manageability service module of the cloud peripheral device workspace orchestrator server have identified any non-compliant node devices. A non-compliant node device may include node devices that were not authorized, via hardware device operational policy, to be part of the peripheral device workspace for example. As such, where a non-compliant node device has been identified, the ITDM may propagate hardware device operational policies to be associated with the non-compliant node device such that settings and configurations of the non-compliant node device are restricted based on those hardware device operational policies within a peripheral device workspace.

In an embodiment, the cloud peripheral device workspace orchestrator server may interface with one or more third-party manageability platforms executing on remote server information handling systems. The one or more third-party manageability platforms may be integrated into or with the cloud peripheral device workspace manageability orchestrator module such that an ITDM may publish hardware device operational policies via the third-party manageability platform for use by the cloud peripheral device workspace orchestrator server executing the cloud peripheral device workspace manageability orchestrator module. This allows an ITDM to interface with any third-party manageability platform via a third-party manageability agent in the peripheral device workspace cloud orchestrator to publish the hardware device operational policies used to dynamically manage the created peripheral device workspaces as those third-party manageability platforms may control or influence operation of one or more nodes, such as peripheral devices, within any peripheral device workspace.

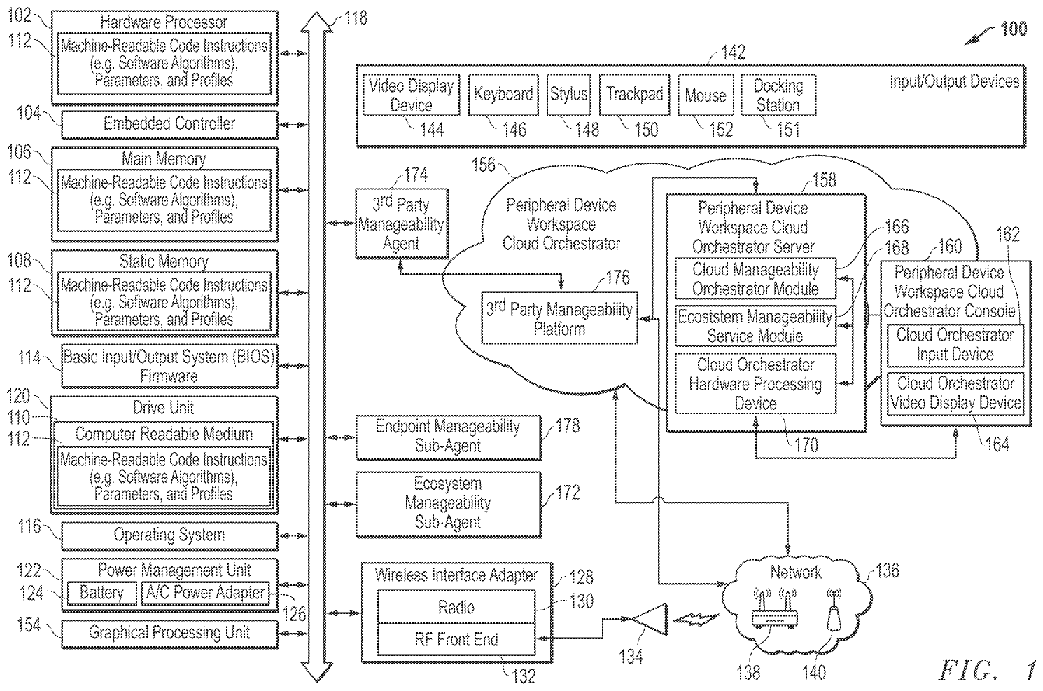

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 138, a base station transceiver 140, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality. It is appreciated that, in some embodiments herein, the information handling system 100 may be one of a plurality of device nodes as part of a peripheral device workspace or a peripheral device workspace cloud orchestrator server 158 that are operatively coupled to a peripheral device workspace cloud orchestrator console 160 in the peripheral device workspace cloud orchestrator 156 described herein. In an embodiment, the cloud orchestrator console 160 may be an information handling system 100 itself that is used by an internet technology decision maker (ITDM) to create hardware device operational policies with one or more peripheral device workspace cloud orchestrator servers 158 to be propagated down to node devices within a peripheral device workspace such as the information handling system 100, a docking station 151, video display device 144, keyboard 146, stylus 148, trackpad 150, mouse 152, and the like. In this embodiment, the information handling system 100, may receive the hardware device operational policies generated by the ITDM at the peripheral device workspace cloud orchestrator console 160 via execution of code instructions of the cloud manageability orchestrator module 166 and the ecosystem manageability service module 168 at the peripheral device workspace cloud orchestrator server 158 as described in embodiments herein.

Thus, in a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 106, (volatile (e.g., random-access memory, etc.), or static memory 108, nonvolatile (read-only memory, flash memory etc.) or any combination thereof), one or more hardware processing resources, such as a hardware processor 102 that may be a central processing unit (CPU), a graphics processing unit (GPU) 103, embedded controller (EC) 104, or any combination thereof. Additional components of the information handling system 100 may include one or more storage devices such as static memory 108 or drive unit 120. The information handling system 100 may include or interface with one or more communications ports for communicating with external devices, as well as various input and output (I/O) devices 142, such as a docking station 151, a mouse 152, a trackpad 150, a keyboard 146, a stylus 148, a video/graphics display device 144, or any combination thereof. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 112 that may operate on servers or systems, remote data centers, or on-box in individual client information handling systems according to various embodiments herein. In some embodiments, it is understood any or all portions of instructions (e.g., software algorithms), parameters, and profiles 112 may operate on a plurality of information handling systems 100.

The information handling system 100 may include the hardware processor 102 such as a central processing unit (CPU). Any of the processing resources may operate to execute code that is either firmware or software code. Moreover, the information handling system 100 may include memory such as main memory 106, static memory 108, and disk drive unit 120 (volatile (e.g., random-access memory, etc.), nonvolatile memory (read-only memory, flash memory etc.) or any combination thereof or other memory with computer readable medium 110 storing instructions (e.g., software algorithms), parameters, and profiles 112 executable by the EC 104, hardware processor 102, GPU 103, or any other hardware processing device. The information handling system 100 may also include one or more buses 118 operable to transmit communications between the various hardware components such as any combination of various I/O devices 142 as well as between hardware processors 102, an EC 104, the operating system (OS) 116, the basic input/output system (BIOS) 114, the wireless interface adapter 128, or a radio module, among other components described herein. In an embodiment, the information handling system 100 may be in wired or wireless communication with the I/O devices 142 such as a docking station 151, a keyboard 146, a mouse 152, video display device 144, stylus 148, or trackpad 150 among other peripheral devices.

The information handling system 100 further includes a video/graphics display device 144. The video/graphics display device 144 in an embodiment may function as a liquid crystal display (LCD), an organic light emitting diode (OLED), a flat panel display, or a solid-state display. It is appreciated that the video/graphics display device 144 may be wired or wireless and may be an external video/graphics display device 144 that allows a user to increase the desktop area by extending the desktop in an embodiment. Additionally, as described herein, the information handling system 100 may include or be operatively coupled to one or more other I/O devices 142 including the wired or wireless mouse 152 described herein that allows the user to interface with the information handling system 100 via the video/graphics display device 144, a cursor control device (e.g., a trackpad 150, or gesture or touch screen input), a stylus 148, and/or a keyboard 146, among others. Information handling system 100 may also be operatively coupled to a peripheral device 142 such as a docking station 151 or other smart peripheral device having a hardware processing device such as a hardware processor, microcontroller, or other hardware processing resource and which may further operatively couple to one or more additional peripheral devices 142. As described herein, each of these input/output devices 142 may each be a node device associated with the information handling system 100 and may be part of a peripheral device workspace defined and identified with a peripheral device workspace identification value via execution of the ecosystem manageability service module 168 and cloud manageability orchestrator module 166 as described herein. Various drivers and hardware control device electronics may be operatively coupled to operate the I/O devices 142 according to the embodiments described herein. The present specification contemplates that the I/O devices 142 may be wired or wireless.

A network interface device of the information handling system 100 shown as wireless interface adapter 128 can provide connectivity among devices such as with Bluetooth® or to a network 136, e.g., a wide area network (WAN), a local area network (LAN), wireless local area network (WLAN), a wireless personal area network (WPAN), a wireless wide area network (WWAN), or other network. In an embodiment, this network 136 may be operatively coupled to or include a peripheral device workspace cloud orchestrator 156 that includes one or more servers (e.g., peripheral device workspace cloud orchestrator server 158) or other computing devices that provide computer system resources as described herein that allow for the creation of peripheral device workspaces and orchestration of different node devices within one or more peripheral device workspaces. In embodiments described herein, the wireless interface device 128 with its radio 130, RF front end 132 and antenna 134 is used to communicate with the wireless peripheral devices via, for example, a Bluetooth® or Bluetooth® Low Energy (BLE) protocols. In an embodiment, the WAN, WWAN, LAN, and WLAN may each include an AP 138 or base station 140 used to operatively couple the information handling system 100 to a network 136. In a specific embodiment, the network 136 may include macro-cellular connections via one or more base stations 140 or a wireless AP 138 (e.g., Wi-Fi), or such as through licensed or unlicensed WWAN small cell base stations 140. Connectivity may be via wired or wireless connection. For example, wireless network wireless APs 138 or base stations 140 may be operatively connected to the information handling system 100. Wireless interface adapter 128 may include one or more radio frequency (RF) subsystems (e.g., radio 130) with transmitter/receiver circuitry, modem circuitry, one or more antenna radio frequency (RF) front end circuits 132, one or more wireless controller circuits, amplifiers, antennas 134 and other circuitry of the radio 130 such as one or more antenna ports used for wireless communications via multiple radio access technologies (RATs). The radio 130 may communicate with one or more wireless technology protocols.

In an embodiment, the wireless interface adapter 128 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, or similar wireless standards may be used. Wireless interface adapter 128 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums. The wireless interface adapter 128 can represent an add-in card, wireless network interface module that is integrated with a main board of the information handling system 100 or integrated with another wireless network interface capability, or any combination thereof.

In some embodiments, software, firmware, dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes instructions, parameters, and profiles 112 or receives and executes instructions, parameters, and profiles 112 responsive to a propagated signal, so that a hardware device connected to a network 136 may communicate voice, video, or data over the network 136. Further, the instructions 112 may be transmitted or received over the network 136 via the network interface device or wireless interface adapter 128. It is appreciated that any computing device including the cloud orchestrator server 158, the cloud orchestrator console 160, and the information handling system 100 may include a computer-readable medium that includes instructions, parameters, and profiles 112.

The information handling system 100 may include a set of instructions 112 that may be executed to cause the computer system to perform any one or more of the methods or computer-based functions disclosed herein. For example, instructions 112 may be executed by a hardware processor 102, GPU 103, EC 104 or any other hardware processing resource and may include software agents, or other aspects or components used to execute the methods and systems described herein. Various software modules comprising application instructions 112 may be coordinated by an OS 116, and/or via an application programming interface (API). An example OS 116 may include Windows®, Android®, and other OS types. Example APIs may include Win 32, Core Java API, or Android APIs.

In an embodiment, the information handling system 100 may include a disk drive unit 120. The disk drive unit 120 and may include machine-readable code instructions, parameters, and profiles 112 in which one or more sets of machine-readable code instructions, parameters, and profiles 112 such as firmware or software can be embedded to be executed by the hardware processor 102 or other hardware processing devices such as a GPU 103 or EC 104, or other microcontroller unit to perform the processes described herein. Similarly, main memory 106 and static memory 108 may also contain a computer-readable medium for storage of one or more sets of machine-readable code instructions, parameters, or profiles 112 described herein. The disk drive unit 120 or static memory 108 also contain space for data storage. Further, the machine-readable code instructions, parameters, and profiles 112 may embody one or more of the methods as described herein. In a particular embodiment, the machine-readable code instructions, parameters, and profiles 112 may reside completely, or at least partially, within the main memory 106, the static memory 108, and/or within the disk drive 120 during execution by the hardware processor 102, EC 104, or GPU 103 of information handling system 100.

Main memory 106 or other memory of the embodiments described herein may contain computer-readable medium (not shown), such as RAM in an example embodiment. An example of main memory 106 includes random access memory (RAM) such as static RAM (SRAM), dynamic RAM (DRAM), non-volatile RAM (NV-RAM), or the like, read only memory (ROM), another type of memory, or a combination thereof. Static memory 108 may contain computer-readable medium (not shown), such as NOR or NAND flash memory in some example embodiments. The applications and associated APIs, for example, may be stored in static memory 108 or on the disk drive unit 120 that may include access to a machine-readable code instructions, parameters, and profiles 112 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 122 (a.k.a. a power supply unit (PSU)). The PMU 122 may include a hardware controller and executable machine-readable code instructions to manage the power provided to the components of the information handling system 100 such as the hardware processor 102 and other hardware components described herein. The PMU 122 may control power to one or more components including the one or more drive units 120, the hardware processor 102 (e.g., CPU), the EC 104, the GPU 103, a video/graphic display device 144, or other wired I/O devices 142 such as the mouse 152, the stylus 148, a keyboard 146, and a trackpad 150 and other components that may require power when a power button has been actuated by a user. In an embodiment, the PMU 122 may monitor power levels and be electrically coupled to the information handling system 100 to provide this power. The PMU 122 may be coupled to the bus 118 to provide or receive data or machine-readable code instructions. The PMU 122 may regulate power from a power source such as the battery 124 or AC power adapter 126. In an embodiment, the battery 124 may be charged via the AC power adapter 126 and provide power to the components of the information handling system 100, via wired connections as applicable, or when AC power from the AC power adapter 126 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 110 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 is operatively coupled to a peripheral device workspace cloud orchestrator 156 that includes any number of servers, computing devices, and other cloud computing resources such as the peripheral device workspace cloud orchestrator server 158. The cloud orchestrator 156 may, therefore, include any hardware that may be distributed over multiple physical locations but act in concert with each other and specifically the peripheral device workspace cloud orchestrator server 158 to facilitate an ITDM to, via hardware device operational policies, create a peripheral device workspace with the one or more node devices (e.g., including the information handling system 100 as a primary or an anchor node device) forming part of the peripheral device workspace after receiving device enrollment data describing one or more node devices, create hardware device operational policies based on the registered node devices detected within the one or more created peripheral device workspaces, and apply the hardware device operational policies to the created peripheral device workspace. It is appreciated that the node devices described herein may include each of the peripheral devices operatively coupled to the information handling system 100 acting as a central, primary or anchor node device and the workspaces created may be described as a peripheral device workspace.

The peripheral device workspace cloud orchestrator server 158 may be any computing device that may include similar elements as the information handling system 100 such as a memory device, a cloud orchestrator hardware processing device 170, a PMU, and other elements that allow the peripheral device workspace cloud orchestrator server 158 to execute code instructions of the cloud manageability orchestrator module 166 and ecosystem manageability service module 168 and other software as described herein. In an embodiment, the peripheral device workspace cloud orchestrator server 158 may be operatively coupled to a peripheral device workspace cloud orchestrator console 160. The peripheral device workspace cloud orchestrator console 160 may be used by the ITDM to create and propagate hardware device operational policies, track a lifecycle of ordered node devices, monitor for compliant and non-compliant node devices within a peripheral device workspace, propagate optimal settings for any give node device or types of node devices, monitor and provide recommended software/firmware updates to node devices, remediate software/firmware issues among the plurality of node devices, manage dynamic peripheral device workspace sessions (e.g., associate a user's identification with a peripheral device workspace), enable automatic security updates for node devices within the peripheral device workspace, mange auto-pairing of node devices to other node devices within the peripheral device workspace, and troubleshoot and remediate node deceives from the cloud orchestrator console 160. It is appreciated that the peripheral device workspace cloud orchestrator console 160 may include a cloud orchestrator input device 162 and a cloud orchestrator video display device 164 that allows the ITDM to complete these processes and engage with the peripheral device workspace cloud orchestrator server 158 in an embodiment.

As described herein, the peripheral device workspace cloud orchestrator server 158 includes a computer-readable program code of a peripheral device workspace cloud manageability orchestrator module 166 that, when executed by the cloud orchestrator hardware processing device 170 of the peripheral device workspace cloud orchestrator server 158, receives device enrollment data describing one or more node devices and creates a peripheral device workspace with the one or more node devices forming part of the peripheral device workspace. In the context of the present specification and in the appended claims, a peripheral device workspace may be an ecosystem of node devices (e.g., including peripheral devices coupled to the information handling system 100, a docking station 151, etc.) connected to a central, primary or anchor node device such as the information handling system 100. In an embodiment, a peripheral device workspace may also be defined with a peripheral device workspace identification value and part of a user composite peripheral device workspace identifier associated with each of the information handling system 100 and peripheral devices (e.g., input/output devices 142) such that a user may have multiple peripheral device workspaces having peripheral device workspace identification values associated with the user based on the context and/or environment of each identified peripheral device workspace. For example, a user composite peripheral device workspace identifier may be used to define a first peripheral device workspace at a home office having a first peripheral device workspace identification value, a second peripheral device workspace at a work office having a second peripheral device workspace identification value, a third peripheral device workspace at a different location (e.g., a coffee shop) having a third peripheral device workspace identification value, and other peripheral device workspaces that can be defined by both the node devices included within the peripheral device workspace and the location of the peripheral device workspace (e.g., defined by location data such as GPS data as well as network data) and having a having a peripheral device workspace identification value.

In an embodiment, the execution of computer-readable program code of the peripheral device workspace cloud manageability orchestrator module 166 causes the peripheral device workspace cloud orchestrator server 158 to receive hardware device operational policies based on the registered node devices detected within the one or more created peripheral device workspaces having peripheral device workspace identification values. In an embodiment, the hardware device operational policies are received from the peripheral device workspace cloud orchestrator console 160 as initiated by the ITDM. The ITDM may be any internet technology decision maker that may decide the hardware device operational policies to be associated with peripheral device workspaces formed at the peripheral device workspace cloud orchestrator server 158 and having peripheral device workspace identification values. For example, the ITDM may decide that certain types of node devices are not allowed to be operatively coupled to a central, primary or anchor node device due to potential security issues associated with those types of node devices. In another example, the ITDM may be any internet technology decision maker that may decide which settings for each of the node devices, including the central, primary or anchor node device, is an optimal and desired setting to be used. In an embodiment, the ITDM may create these hardware device operational policies and desired settings at the peripheral device workspace cloud orchestrator console 160 which propagates these hardware device operational policies to the peripheral device workspace cloud orchestrator server 158 executing the peripheral device workspace cloud manageability orchestrator module 166. Upon receipt of these hardware device operational policies created at the peripheral device workspace cloud orchestrator console 160 by the ITDM, the execution of the peripheral device workspace cloud manageability orchestrator module 166 may propagate these hardware device operational policies to each of the device nodes within the created peripheral device workspace thereby eliminating the need for the ITDM to manually address each device node to propagate these hardware device operational policies.

In an embodiment, the peripheral device workspace cloud orchestrator server 158 may also execute computer readable program code of an ecosystem manageability service module 168. Execution of the ecosystem manageability service module 168 applies the hardware device operational policies to the created peripheral device workspace. In an embodiment, the peripheral device workspace cloud manageability orchestrator module 166 creates hardware device operational policies for each of the one or more node devices within the peripheral device workspace based on received hardware device operational policies created by the ITDM. As described herein, the ecosystem manageability service module 168 may identify those peripheral devices that form part of the peripheral device workspace having a peripheral device workspace identifier value and may propagate those hardware device operational policies that apply to those peripheral devices. For example, where a plurality of peripheral device workspaces with a plurality of peripheral device workspace identifier values each include a specific wireless mouse that the ITDM has created a hardware device operational policy for, the execution of the computer-readable program code of the ecosystem manageability service module 168 causes the peripheral device workspace cloud orchestrator server 158 to send those hardware device operational policies to the appropriate peripheral device workspace (e.g., to each of the central, primary or anchor node devices) so that those hardware device operational policies may be passed to the wireless mice in each peripheral device workspace having a peripheral device workspace identifier value where such as specific mouse model or type is located.

During operation, an ITDM may order a variety of services provided by or to the peripheral device workspace cloud orchestrator server 158 as described herein. In an embodiment, the ITDM may create login information that can be used to subsequently log onto the peripheral device workspace cloud orchestrator server 158 via the peripheral device workspace cloud orchestrator console 160. Once logged into the peripheral device workspace cloud orchestrator server 158, the ITDM may be presented with a number of graphical user interfaces (GUIs) that allow the ITDM to view, for example, those peripheral device workspaces identified with peripheral device workspace identification values and created via execution of the cloud manageability orchestrator module 166 as described herein. The ITDM may also, via the peripheral device workspace cloud orchestrator console 160 and using the cloud orchestrator input device 162 and cloud orchestrator video display device 164, provide input to the peripheral device workspace cloud orchestrator server 158 indicating hardware device operational policies to be applied to the various node devices (e.g., a central, primary or anchor node device and operatively coupled peripheral devices) at any peripheral device workspace. Still further, the ITDM may use the peripheral device workspace cloud orchestrator console 160 to monitor software/firmware updates that can be applied to the various node devices at any peripheral device workspace identified with a peripheral device workspace identifier value. In a specific embodiment, the ITDM may access an online purchasing store or other ordering system that allows the ITDM to purchase peripheral devices and other hardware devices that can be added within the created peripheral device workspaces having peripheral device workspace identification values and associated with a plurality of users via one or more user composite peripheral device workspace identifiers. For example, the ITDM may order a new wireless keyboard for each of the central, primary or anchor node devices (e.g., one or more information handling systems 100) operatively coupled to the peripheral device workspace cloud orchestrator server 158 via the peripheral device workspace cloud orchestrator 156. This purchasing data may be passed onto the peripheral device workspace cloud orchestrator server 158 executing the computer-readable program code of the peripheral device workspace cloud manageability orchestrator module 166 such that these node devices, when operatively coupled to the central, primary or anchor node device, may be automatically coupled to the central, primary or anchor node device and indicated as forming part of at least one peripheral device workspace with a peripheral device workspace identification value. When the newly added peripheral device (e.g., a keyboard in this example) is coupled to the central, primary or anchor node device, the execution of the peripheral device workspace cloud manageability orchestrator module 166 causes the created peripheral device workspace to be updated to indicate that the new wireless keyboard has been added to the peripheral device workspace and with its peripheral device workspace identification value. This information is presented to the ITDM at the peripheral device workspace cloud orchestrator video display device 164 of the peripheral device workspace cloud orchestrator console 160 thereby notifying the ITDM that the user of the information handling system 100 has received and operatively coupled the wireless keyboard to the information handling system 100 forming the peripheral device workspace with a peripheral device workspace identification value.

In an embodiment, the peripheral device workspace cloud orchestrator server 158 may search a node device database operatively coupled to the peripheral device workspace cloud orchestrator server 158 for the newly added wireless keyboard based on the ID of the peripheral device received by an ecosystem manageability sub-agent 172 executed by the hardware processor 102 of the information handling system 100. This node device database may provide the peripheral device workspace cloud orchestrator server 158 with details regarding the node devices detected and forming the peripheral device workspaces and associated particular peripheral device workspace identification values described herein. For example, the node device database may include data regarding the possible settings for any given node device, compatibility of these node devices with other node devices within any given peripheral device workspace, and capabilities of the node devices among other characteristics and features of the node devices. Thus, the ecosystem manageability sub-agent 172 may be executed on the information handling system 100 to provide data to and receive hardware device operational policies and/or software/firmware updates from the peripheral device workspace cloud orchestrator server 158 based on the detection of specifically-identified node devices within each peripheral device workspace having a peripheral device workspace identification value. This allow the ITDM to, via the peripheral device workspace cloud orchestrator console 160, to provide hardware device operational policies that affect the organization of the peripheral device workspaces as well as the updating of firmware/software for each of the device nodes.

In an embodiment, the peripheral device workspace cloud orchestrator 156 with the peripheral device workspace cloud orchestrator server 158 may be operatively coupled to a third-party manageability platform 176. A third-party manageability platform 176 may include any endpoint management service such as Microsoft® Intune® that is used to help manage the remote workspaces. The use of the third-party manageability platforms 176 allows an ITDM to help create the workspaces, define the workspaces, register peripheral devices (e.g., node devices) with the peripheral device workspace cloud orchestrator server 158, modify created workspaces each having peripheral device workspace identification values based on detected changes (e.g., inclusion of new node devices, removal of node devices, and swapping of node devices within the workspace, etc.) within any given peripheral device workspace. It is appreciated that any number of third-party manageability platforms 176 operatively coupled to the peripheral device workspace cloud orchestrator server 158 within the peripheral device workspace cloud orchestrator 156 may be used to allow the ITDM to perform these actions as described herein. The peripheral device workspace cloud orchestrator server 158 may, therefore, act as a central location where an ITDM may, via the peripheral device workspace cloud orchestrator console 160, access data describing each created peripheral device workspace, make changes to the peripheral device workspaces, and submit hardware device operational policies to be applied to any of the node devices within each peripheral device workspace as well as conduct software/firmware updates for all necessary node devices with the execution of the third-party manageability platform 176 within the peripheral device workspace cloud orchestrator 156. In order for the third-party manageability platform 176 to receive data regarding each node device within the peripheral device workspaces, an ecosystem manageability sub-agent 172 and third-party manageability agent 174 may be executed by a hardware processor 102 of an information handling system 100 acting as the central, primary or anchor node device for a peripheral device workspace. The ecosystem manageability sub-agent 172 may gather the node device characteristics from the endpoint manageability sub-agent 178 and transmit that data to the third-party manageability platform 176 which shares this data with the peripheral device workspace cloud orchestrator server 158.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

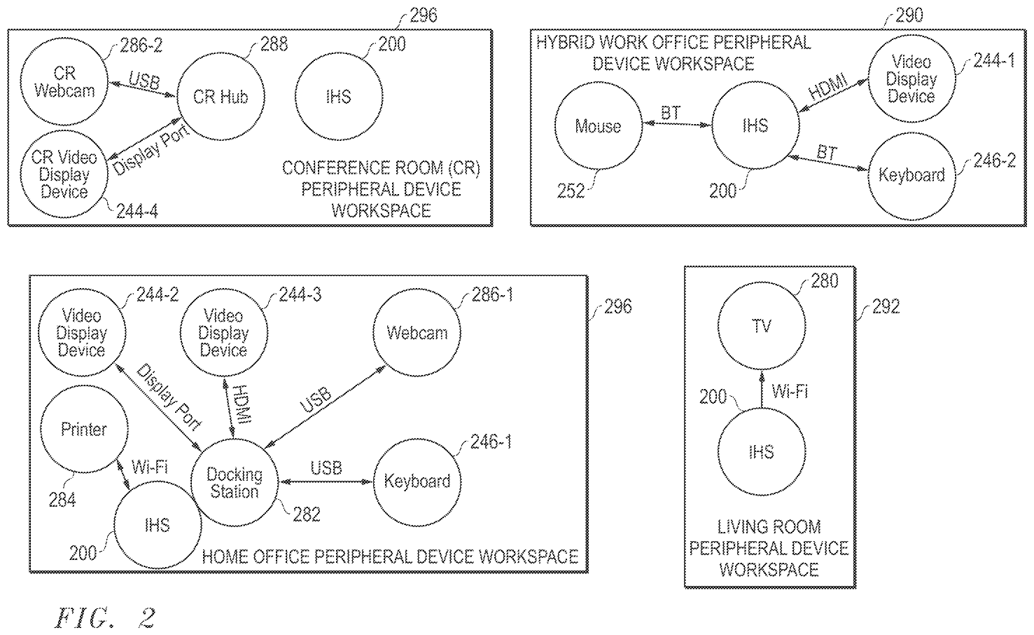

FIG. 2 is a graphic diagram of a plurality of peripheral device workspaces formed among a plurality of nodes that may form a peripheral device workspace 290, 292, 294, 296 according to another embodiment of the present disclosure. FIG. 2 shows that multiple devices may be included within any created peripheral device workspaces 290, 292, 294, 296 and any individual node device, peripheral device, or primary or anchor node device may be included within a plurality of the peripheral device workspaces 290, 292, 294, 296.

FIG. 2 shows a first peripheral device workspace indicated as a hybrid work office peripheral device workspace 290. The hybrid work office peripheral device workspace 290 may be a peripheral device workspace 290 that is defined by, for example, the physical location of the information handling system 200 acting as the primary or anchor node device for example. In an example embodiment, an ecosystem manageability sub-agent executed by a hardware processor on the information handling system (IHS) 200 that reads or detects a location of the information handling system 200 based on, for example, operatively coupled wireless systems (e.g., base station or access points) or location data received from a GPS system or the like. Other data may also be detected by the ecosystem manageability sub-agent describing the individual peripheral devices or node devices within the hybrid work office peripheral device workspace 290. These peripheral devices within the hybrid work office peripheral device workspace 290 may include, in the example in FIG. 2, a video display device 244-1, keyboard 246-2, and a mouse 252. Each of these peripheral devices may be either wired or wireless devices that form part of the hybrid work office peripheral device workspace 290. In the example in FIG. 2, the keyboard 246-2 and mouse 252 are operatively coupled to the primary or anchor node device (e.g., the information handling system 200) via a Bluetooth® or Bluetooth® Low Energy (BLE) connection. In the embodiment shown in FIG. 2, the video display device 244-1 is operatively coupled to the information handling system 200 via a high-definition multimedia interface (HDMI) connection which is a wired connection. Regardless of the type of connection, the execution of the ecosystem manageability sub-agent by the hardware processor of the information handling system 200 causes the characteristics of these peripheral devices 244-1, 246-2, and 252 to be retrieved and passed onto the ecosystem manageability service module of the peripheral device workspace cloud orchestrator server via an endpoint manageability sub-agent also being executed on the information handling system 200. Again, in an embodiment, a third-party manageability platform may be operatively coupled to the third-party manageability agent and the peripheral device workspace cloud orchestrator server such that this data is passed onto the ecosystem manageability service module for the ITDM to see via the peripheral device workspace cloud orchestrator console as described herein.

It is appreciated that execution of the ecosystem manageability service module by the cloud orchestrator hardware processing device on the peripheral device workspace cloud orchestrator server causes the peripheral device workspace cloud orchestrator server to create or define the various peripheral device workspaces such as the hybrid work office peripheral device workspace 290 and other peripheral device workspaces described herein and assign a peripheral device workspace identification values for each peripheral device workspace. The peripheral device workspace cloud orchestrator server may create each peripheral device workspace defined with its peripheral device workspace identification value, location indicator, and a manifest of nodes of peripheral devices and central devices that may operate in the peripheral device workspace. Additional information may be included in the definition of the peripheral device workspace and associated with its peripheral device workspace identification value defined at the peripheral device workspace cloud orchestrator including a manifest of capabilities, connectivity details, and other features of nodes within the peripheral device workspace. For example, the execution of the ecosystem manageability service module may create other peripheral device workspaces that include the living room peripheral device workspace 292, the home office peripheral device workspace 294, and the conference room (CR) peripheral device workspace 296. The creation or formation of the living room peripheral device workspace 292, for example, includes the information handling system 200 as the primary or anchor node device and a television 280. In an embodiment, the television 280 may serve as an external monitor for the information handling system 200 and may be operatively coupled to the information handling system 200 via a Wi-Fi wireless connection.

Furthermore, execution of the ecosystem manageability service module causes the home office peripheral device workspace 294 to be formed or created. The home office peripheral device workspace 294 may include the information handling system 200 operatively coupled to a docking station 282. This docking station 282 may be operatively coupled to the information handling system 200 via a wired connection for example. The information handling system 200 in the home office peripheral device workspace 294 may be wirelessly coupled to a printer 284 via a wireless connection such as a Wi-Fi connection. The information handling system 200 in the home office peripheral device workspace 294 may also be operatively coupled to other peripheral devices via the docking station 282 such as a first video display device 244-2 (different from the video display device 244-1 within the hybrid work office peripheral device workspace 290), a second video display device 244-3 (again, also different from other video display devices), a webcam 286-1, and a keyboard 246-1 (also different from other keyboards in other peripheral device workspaces). The first video display device 244-2 may be operatively coupled to the docking station 282 and the information handling system 200 via a display port (DS) wired connection while the second video display device 244-3 may be operatively coupled to the docking station 282 and information handling system 200 via an HDMI wired connection. The webcam 286-1 and keyboard 246-1 may be operatively coupled to the docking station 282 via a universal serial bus (USB) connections. Again, it is appreciated that location data and data associated with the peripheral devices may be used by the peripheral device workspace cloud orchestrator server executing the ecosystem manageability service module to create and define the home office peripheral device workspace 294 and associate the location, manifest of nodes (e.g., each peripheral device operatively coupled to the anchor nodes information handling system), and other aspects of peripheral devices with a peripheral device workspace identification value in a memory database at or coupled to the peripheral device workspace cloud orchestrator server.

Even further, a conference room peripheral device workspace 296 may be formed by execution of the ecosystem manageability service module on the peripheral device workspace cloud orchestrator server and associate the location, manifest of nodes, and other aspects of peripheral devices with a peripheral device workspace identification value in a memory database at or coupled to the peripheral device workspace cloud orchestrator server. The conference room peripheral device workspace 296 may be located within a conference room of an enterprise. Like the other peripheral device workspaces 290, 292, and 294, the conference room peripheral device workspace 296 includes a plurality of peripheral devices that form part of the conference room peripheral device workspace 296. For example, the information handling system 200 may be within the physical room of the conference room that includes a conference room hub 288, a conference room video display device 244-4, and a conference room webcam 289-2. The information handling system may not be operatively coupled to any device but may be placed within the conference room peripheral device workspace 296 based on the detected physical location of the information handling system 200. This allows the user of the information handling system 200 to engage with the information handling system 200 and the conferencing system without necessarily operatively coupling the information handling system 200 to the conference room hub 288. As seen in FIG. 2, the conference room hub 288 is operatively coupled to the conference room video display device 244-4 via a DP wired connection. Still further, the conference room hub 288 may be operatively coupled to the conference room webcam 286-2 via a USB wired connection.

In an embodiment, the formation and definition of each of these workspaces 290, 292, 294, and 296 and association of each location, manifest of nodes, and other aspects of the peripheral devices with a unique peripheral device workspace identification value may be stored on a database operatively coupled to the cloud orchestrator server. These created peripheral device workspaces 290, 292, 294, and 296 may be stored on the database operatively coupled to the cloud orchestrator server such that an ITDM may access any stored peripheral device workspace that is associated with any user, any information handling system 200, or other specific or type of peripheral device. For example, the ITDM may access the database and receive a list of peripheral device workspaces or nodes and, with linking to one or more user composite peripheral device workspace identifiers, determine which peripheral device workspaces are assigned to a specific user or which include a specific information handling system 200. This allows the ITDM to see which peripheral devices are included in these workspaces and whether, in an example embodiment, each peripheral device is compliant or not or whether firmware/software updates are needed for each of the peripheral devices. An ITDM may also be provided with data describing the capabilities or attributes of each of the peripheral devices for peripheral device workspaces from their peripheral device workspaces identification values that allow the ITDM to push hardware device operational policies to each peripheral device based, for example, on which peripheral device workspace 290, 292, 294, and 296 that those types of peripheral devices are currently within.

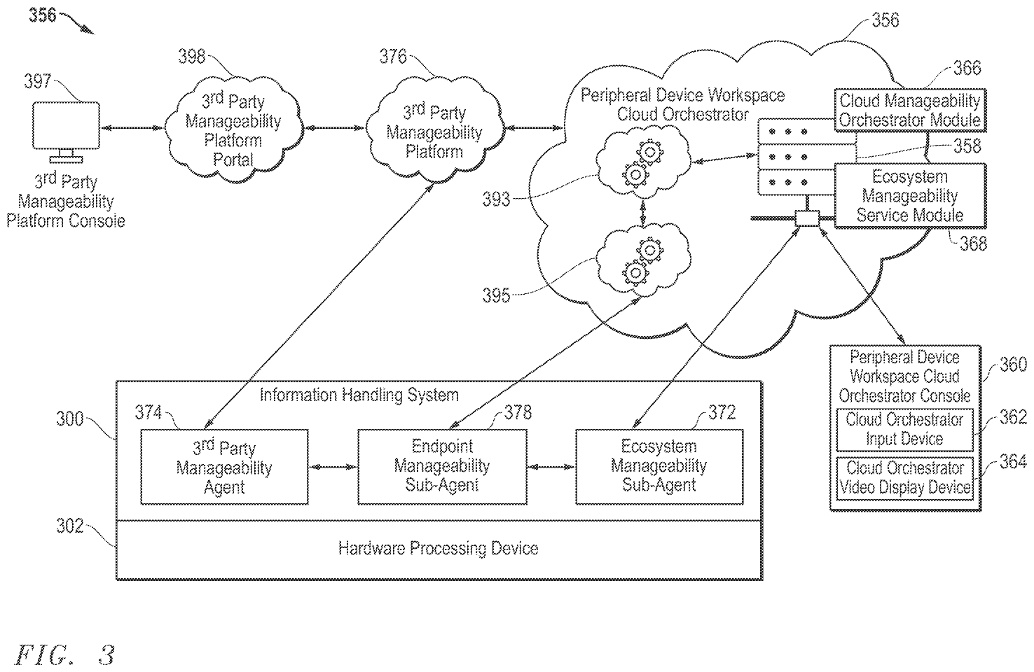

FIG. 3 is a graphic diagram of a peripheral device workspace cloud orchestrator 356 and an information handling system 300 used to manage and orchestrate peripheral device workspaces according to another embodiment of the present disclosure. FIG. 3 shows an information handling system 300 operatively coupled to the peripheral device workspace cloud orchestrator 356 and its peripheral device workspace cloud orchestrator server 358 described herein.

As described herein, the peripheral device workspace cloud orchestrator 356 includes a peripheral device workspace cloud orchestrator server 358 used to execute computer-readable program code of a cloud manageability orchestrator module 366 and an ecosystem manageability service module 368. As described herein, the ecosystem manageability service module 368 may be used to receive data describing one or more created peripheral device workspaces that are defined as including an anchor device node such as the information handling system 300 as well as other peripheral devices operatively coupled to the information handling system 300 either via a wired or wireless connection in a location and associated with a peripheral device workspace identification value. In an embodiment, the ecosystem manageability service module 368 may create a unique identifier for each peripheral device node discovered by the execution of the computer-readable program code of the ecosystem manageability sub-agent 372 on the information handling system 300 in a particular peripheral device workspace and associated with a peripheral device workspace identification value. The execution of the ecosystem manageability service module 368 may also cause a peripheral device workspace to be updated with the identification of each of the peripheral devices and device nodes within the peripheral device workspace at that location and associated with the peripheral device workspace identification value. In an embodiment, the ecosystem manageability service module 368 may also be used to communicate with the ecosystem manageability sub-agent 372 on the information handling system 300 so that hardware device operational policies and firmware/software updates configured by an ITDM at a peripheral device workspace cloud orchestrator console 360 can be propagated down to the information handling system 300 and the appropriate peripheral devices within a given peripheral device workspace. In some embodiments, the execution of the ecosystem manageability service module 368 by the hardware processor of the peripheral device workspace cloud orchestrator server 358 may also transmit hardware device operational policies identification data back to the cloud manageability orchestrator module 366 and is mapped to each created workspaces. Thus, such hardware device operational policies or firmware/software updates may then be identified as completed for the peripheral device workspace identification value of a particular peripheral device workspace.

As described herein, the execution of the computer-readable program code of the cloud manageability orchestrator module 366 causes the peripheral device workspace cloud orchestrator server 358 to access a management database to search for peripheral devices within that management database that have been identified by the ecosystem manageability sub-agent 372 in the information handling system 300 as being part of the created peripheral device workspace and associated with the peripheral device workspace identification value. When peripheral device or other node data has been found within the management database, the cloud manageability orchestrator module 366 may make changes to the peripheral device workspace such as registering existing or new peripheral devices to the peripheral device workspace, propagating hardware device operational policies and firmware/software updates to those peripheral devices, and updating the manifest data associate with the peripheral device workspace identification value. The cloud manageability orchestrator module 366 may also receive, from the peripheral device workspace cloud orchestrator console 360 operated by an ITDM, those selected hardware device operational policies and firmware/software updates requested to be made within each of the created peripheral device workspaces. The execution of the computer-readable program code of the cloud manageability orchestrator module 366 provides data describing the created peripheral device workspaces, currently applied hardware device operational policies to each device node, current firmware/software status for each node device, organization of each peripheral device workspace associated with a peripheral device workspace identification value. Further, the peripheral device workspace identification value may be associated with a user associated with each peripheral device workspace via the composite peripheral device workspace identifier for a user identifying peripheral device workspaces for that user at the peripheral device workspace cloud orchestrator console 360 which may display this data to the ITDM on, for example, a cloud orchestrator video display device 364. This allows the ITDM to interface with those GUIs presented on the cloud orchestrator video display device 364 and interact with and make changes to the created peripheral device workspaces. The ITDM may interact with these presented GUIs using, for example, any cloud orchestrator input device 362 which may include a mouse, a keyboard, a stylus, or trackpad and the like.

The peripheral device workspace cloud orchestrator 356 may also include a third-party proxy cloud orchestrator service 393. The third-party proxy cloud orchestrator service 393 may allow the peripheral device workspace cloud orchestrator 356 to interface with the third-party manageability platform 376 which may include, in an example embodiment, Microsoft® Intune® that is used to help manage specific peripheral devices the remote workspaces. It is appreciated that any third-party manageability platform 376 may be used and the ITDM may access this third-party manageability platform 376 to provide hardware device operational policies that are passed onto the peripheral device workspace cloud orchestrator server 358 for distribution by the cloud manageability orchestrator module 366 as described herein. The ITDM may do this by accessing and updating, altering, or otherwise using administrative templates (ADMXs) that help the ITDM to define these hardware device operational policies. The ITDM may, in an embodiment, access the third-party manageability platform 376 through a third-party manageability platform console 397 and third-party manageability platform portal 398 that allows the ITDM to gain access to these ADMXs.

In an embodiment, the third-party proxy cloud orchestrator service 393 executed by the hardware processing device 302 of the information handling system 300 or other primary or anchor node with processing capability may interface with a content management system server 395 that may interface with the endpoint manageability sub-agent 378 such that the content management system server 395 is registered with a content management application or otherwise checks-in with the endpoint manageability sub-agent 378 on a periodic basis. This allows the endpoint manageability sub-agent 378 to read the data associated with the detected node devices from the ecosystem manageability sub-agent 372 and enroll those devices with the third-party manageability platform 376. In other aspects, information handling system 300 or another primary or anchor node with processing and network capability may execute code instructions of a third-party manageability agent 374 which may, in whole or in part, interface directly with the third-party manageability platform 376 executing remotely at a third-party server system. It is appreciated that the computer-readable program code of the ecosystem manageability sub-agent 372, third-party manageability agent 374, and the endpoint manageability sub-agent 378 may be executed by the hardware processing device 302 of the information handling system 300 to perform these and other processes described herein.

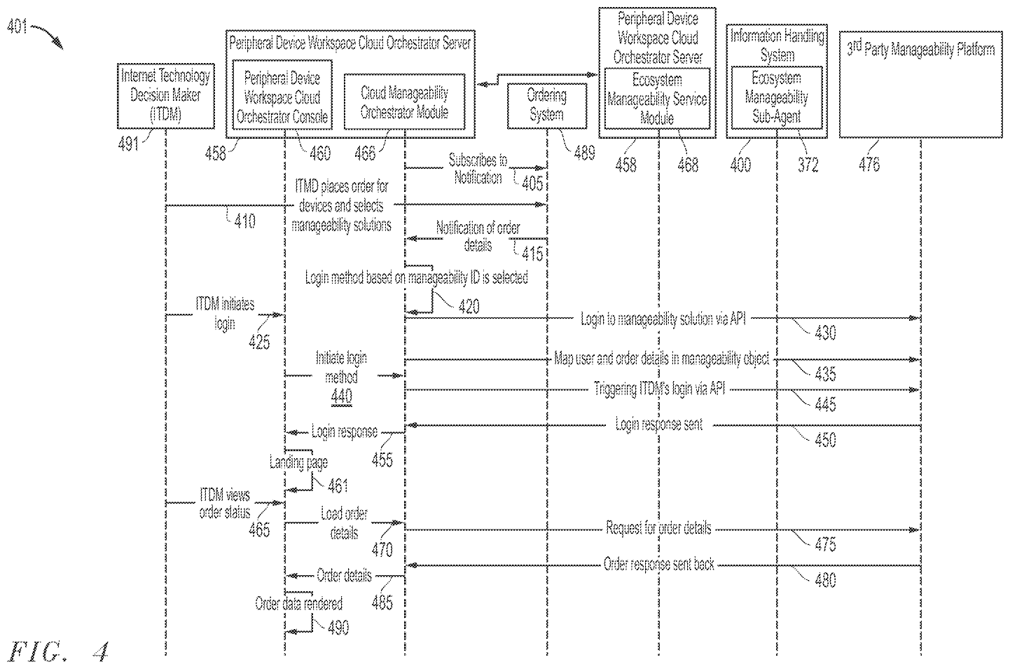

FIG. 4 is a flow chart showing a method 401 of an ITDM 491 using a peripheral device workspace cloud orchestrator console 560 operatively coupled to a peripheral device workspace cloud orchestrator server 558 for ordering a subscription and to manage and orchestrate node devices or peripheral devices within one or more established peripheral device workspaces for an enterprise according to an embodiment of the present disclosure. The method 401 describes a situation where the ITDM 491 can order a subscription to those services provided via execution of the computer-readable program code of the cloud manageability orchestrator module 466 and ecosystem manageability service module 468 on the peripheral device workspace cloud orchestrator server 458 described herein.

At line 405, the cloud manageability orchestrator module 466 may subscribe to notifications via the ordering system 489. The ordering system 489 software executing on a remote server information handling system that may be any online marketplace that allows, for example, an ITDM 491 to order the services for peripheral devices managed by the ITDM 491 and those services are provided by the peripheral device workspace cloud orchestrator server 458 described herein. The ordering system 489 may be operatively coupled to the peripheral device workspace cloud orchestrator server 458 via a network such as that described in connection with FIG. 1 and may allow for input of financial resources used to pay for the services.

At line 410, the ITDM 491 may place an order for any number of peripheral devices or other devices such as an information handling system (e.g., that may serve as a primary or anchor node) that may be used to form a peripheral device workspace. It is appreciated that when the ITDM 491 orders these peripheral devices, it may be for a plurality of users within, for example, an enterprise. The ITDM 491 may order a fleet of peripheral devices or one or more information handling systems 400 such that this fleet of node devices may be managed more easily with each user using the same or similar node devices. The ordering of these peripheral devices may be accomplished on an online market such as Dell.com operated by Dell Inc.® at an ordering system 489 executing on a remote server. It is appreciated that any type of ordering system 489 may be used and the present specification contemplates these other types of purchasing peripheral devices and information handling systems 400.

At line 415, the cloud manageability orchestrator module 466 may be notified of the ordering details associated with the ordered peripheral devices and information handling systems by the ITDM 491. The notification of the details of the ordered peripheral devices and information handling systems allows the cloud manageability orchestrator module 466 to, as described herein, look up details regarding these peripheral devices and information handling systems that allows the cloud manageability orchestrator module 466 to, in an embodiment, receive device enrollment data describing one or more node devices and create a peripheral device workspace having a unique peripheral device workspace identification value with the one or more node devices forming part of the peripheral device workspace as well as receive hardware device operational policies based on the registered node devices detected within the one or more created peripheral device workspaces.

At line 420, a login method into the peripheral device workspace cloud orchestrator server 458 may be selected based on a manageability identification (ID). For example, an ITDM 491 may be provided with a manageability ID that indicates to the peripheral device workspace cloud orchestrator server 458 and the cloud manageability orchestrator module 466 the identification of the ITDM 491 engaging with the peripheral device workspace cloud orchestrator server 458 and authorization to access data and information for management of one or more enterprise-owned peripheral devices as well as one or more peripheral device workspaces having peripheral device workspace identification values. In an embodiment, the ITDM 491 may select a username and password that provides the ITDM 491 with exclusive access to the peripheral device workspace cloud orchestrator server 458 and gain access to the data associated with the ordered peripheral devices and information handling systems as well as any data associated with the created peripheral device workspaces as described herein.

At line 425, the ITDM 491 may initiate a login process. Again, this login process may include the ITDM 491, via a peripheral device workspace cloud orchestrator console 460, providing a username and password assigned to or selected by the ITDM 491 according to the selected login method from block 420 above. This login process includes, at line 430, logging into the cloud manageability orchestrator module 466 as the manageability solution for a plurality of peripheral device nodes as well as logging into a third-party manageability platform 476 using an application program interface (API) associated with the third-party manageability platform 476. Again, as described herein, a third-party manageability platform 476 may include any endpoint management service such as Microsoft® Intune® that is used to help manage certain peripheral device nodes at various peripheral device workspaces managed by the cloud manageability orchestrator module 466 executing on the peripheral device workspace cloud orchestrator server 458. The use of the third-party manageability platforms 476 allows an ITDM 491 to further help create the peripheral device workspaces with details and functions of peripheral device nodes, define the peripheral device workspaces with details and functions of peripheral device nodes, register peripheral devices (e.g., node devices) with the peripheral device workspace cloud orchestrator server 458, and modify created peripheral device workspaces for the relevant peripheral device nodes based on detected changes (e.g., inclusion of new node devices, removal of node devices, and swapping of node devices within the workspace, etc.) within any given peripheral workspace. The cloud manageability orchestrator module 466 executing on the peripheral device workspace cloud orchestrator server 458 may access and reference the third-party manageability platforms 476 for updates, functionality of peripheral device nodes, for adjustments to peripheral device performance capabilities, and for other functions relevant to management of the peripheral device workspaces having peripheral device workspace identification values. Such peripheral device nodes in the managed peripheral device workspaces may need to be partially managed through interface with the third-party manageability platforms 476, for example, in some embodiments.

At line 435, as part of the interfacing with the third-party manageability platforms 476 for peripheral device nodes within managed peripheral device workspaces, the cloud manageability orchestrator module 466 may concurrently map user and order details into a manageability object at the third-party manageability platform 476. Again, the ITDM 491, when ordering the peripheral devices and information handling systems, may identify the enterprise-owned peripheral device nodes, assign such peripheral to a peripheral device workspace identification value, and associate each of these devices with a specific user via a composite peripheral device workspace identifier for users thereby assigning these devices to be used by these users. This data is mapped to the manageability object such that the third-party manageability platform 476 is notified of which of the ordered devices are to be associated with which users.

At line 440 the login method that was selected is initiated when the ITDM initiates login at block 425. The login credentials are passed onto the third-party manageability platforms 476 with the cloud manageability orchestrator module 466 at line 445 triggering the ITDM's 491 login via the API from blocks 425 and block 440. A login response is sent back to the cloud manageability orchestrator module 466 from the third-party manageability platform 476 at line 450 to the cloud manageability orchestrator module 466 which passes the login response back to the peripheral device workspace cloud orchestrator console 460 operated by the ITDM 491 at line 455.

At line 461, a landing page or any other GUI may be displayed on a video display device associated with the peripheral device workspace cloud orchestrator console 460 upon authentication of the login for the cloud manageability orchestrator module 466 on the peripheral device workspace cloud orchestrator server 458, and at the third-party manageability platforms 476. This allows the ITDM 491 to begin to interface with the created peripheral device workspaces and the variously assigned peripheral devices as well as coordinate with any relevant third-party manageability platforms 476 for such management. Again, the ITDM 491 may be presented or be provided with access to various GUIs from the cloud manageability orchestrator module 466 that allow the ITDM 491 to view the status of each of the peripheral devices, information handling systems, and created peripheral device workspaces as described herein. The cloud manageability orchestrator module 466 may provide such GUIs in order to provide hardware device operational policies at the ecosystem manageability service module 468 from the enterprise as well as any hardware device operational policies from a third-party manageability platform 476 to be passed onto these peripheral devices and to manage the identified peripheral device workspaces for those peripheral devices as well as for any identified user or users of those devices. In an additional example embodiment, the cloud manageability orchestrator module 466 may provide a GUI for an ITDM 491 to determine whether the peripheral devices are compliant or non-compliant devices, as well as monitor and prescribe updates to firmware/software for these devices including through links to the third party manageability platforms 476 for any peripheral device nodes relevant or provided by that particular third party. It is understood that the method of FIG. 4 may interface in the above way with a plurality of third party manageability platforms 476 since the fleet of peripheral device nodes in an enterprise needing to be managed may be sourced from a plurality of third-party vendors in embodiments herein.

At line 465, the ITDM 491 may view the order status of any ordered devices such as those ordered at line 410. For example, at line 465, the ITDM 491 may monitor the transportation of the ordered devices to the users, determine when the peripheral devices and/or information handling systems have been powered on with the peripheral devices operatively coupled to the information handling systems in a location and associated with a peripheral device workspace identification value, and the like. These order details are loaded onto the cloud manageability orchestrator module 466 by the peripheral device workspace cloud orchestrator console 460 at line 470. In an embodiment, some of the details regarding these orders may be requested by the cloud manageability orchestrator module 466 from the third-party manageability platform 476 at line 475 for corresponding third-party sourced peripheral devices with the ecosystem manageability service module 468 returning those details to the cloud manageability orchestrator module 466 at line 480. At line 485 these order details are transmitted from the cloud manageability orchestrator module 466 to the peripheral device workspace cloud orchestrator console 460 so that this order data is rendered on the video display device of the peripheral device workspace cloud orchestrator console 460 at line 490. FIG. 4 shows the process an ITDM 491 may take to register ordered devices at the third-party manageability platform 476 and peripheral device workspace cloud orchestrator server 458 in preparation for the ITDM 491 to manage the peripheral devices, information handling systems, and the developed peripheral device workspaces for users and from a plurality of potential third party vendors as described in embodiments herein.

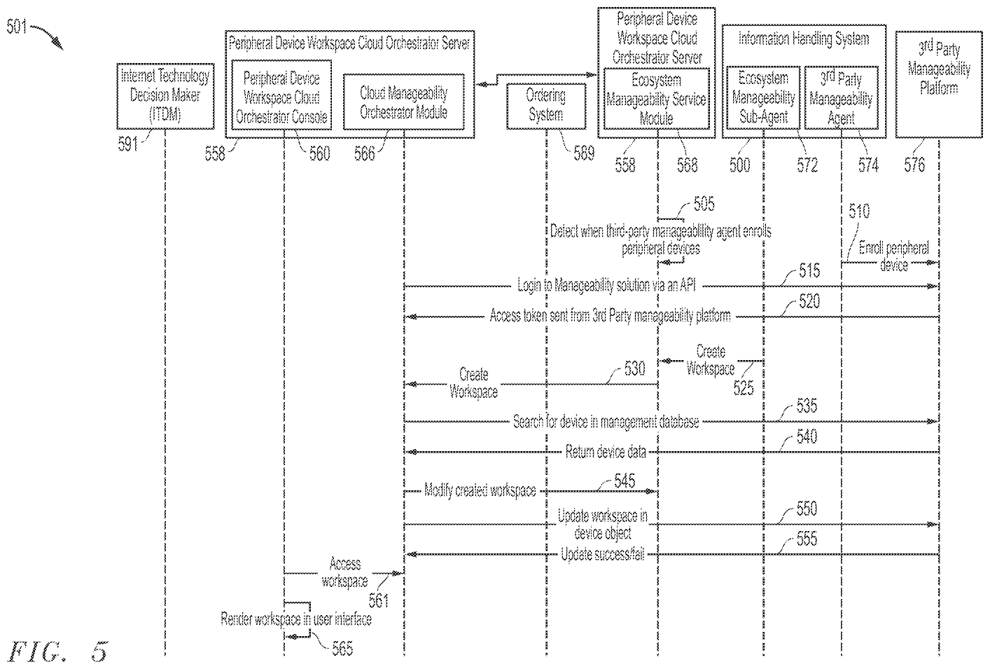

FIG. 5 is a flow chart showing a method 501 of executing code instructions of a cloud manageability orchestrator module 566 on a peripheral device workspace cloud orchestrator server 558 to automatically create one or more peripheral device workspaces to manage and orchestrate node devices within the created peripheral device workspaces according to an embodiment of the present disclosure. An ITDM may be involved in the process by providing input at a peripheral device workspace cloud orchestrator console 560 to provide input at the peripheral device workspace cloud orchestrator console 560 that is used to manage the peripheral devices and information handling systems of each peripheral device workspace created.

In an embodiment, at line 505, the computer-readable program code of the ecosystem manageability sub-agent 572 is executed by a hardware processing device of the information handling system 500 in order to detect when a third-party manageability agent 574 executing on the information handling system 500 has enrolled a peripheral device or information handling system as operating within a peripheral device workspace. This process of detecting when the third-party manageability agent 574 enrolls peripheral devices may be continuous in an embodiment. In another embodiment, the execution of the ecosystem manageability sub-agent 572 may periodically determine if and when the third-party manageability agent 574 has enrolled any peripheral devices at line 510 as operating with the peripheral device workspace.

At line 515, the cloud manageability orchestrator module 566 may log into the third-party manageability platform 576 via the API described herein. In an embodiment, the third-party manageability platform 576 and cloud manageability orchestrator module 566 may work in concert to provide to the cloud manageability orchestrator module 566 any enrollment data and device ID data associated with any enrolled peripheral devices as well as any other information on capabilities of, updates for, or other data and aspects of particular peripheral devices supported by such a third party. As described herein, the cloud manageability orchestrator module 566 may log into a plurality of third-party manageability platforms 576 via the APIs described herein for supporting a variety of types of third-party peripheral devices that operate within defined peripheral device workspaces according to embodiments herein.

At line 520 an access token from the one or more third-party manageability platforms 576 may be provided to the cloud manageability orchestrator module 566. This access token allows the cloud manageability orchestrator module 566 to gain access to the device data for each enrolled peripheral device and information handling system from each corresponding third-party manageability platform 576.

At line 525, the ecosystem manageability sub-agent 572 may create a peripheral device workspace by identifying a manifest of those peripheral devices and information handling systems that are operated by a specific user, a location where the manifest of those peripheral devices and information handling systems are being operated, and the association of any peripheral devices to the information handling system. The peripheral device identification numbers, such as serial numbers, of peripheral devices in the manifest at a peripheral device workspace as well as a location value for a peripheral device workspace may be defined with a peripheral device workspace identification value by the cloud manageability orchestrator module 566 and stored in a peripheral device workspace database for reference by an ITDM of an enterprise as described in embodiments herein. Further, the peripheral device workspaces identified by peripheral device workspace identification values in the peripheral device workspace database may include data stored on the peripheral device workspace database and associated with each peripheral device workspace identification value. This data for each peripheral device workspace includes peripheral device identification identifiers unique to each peripheral device in the manifest of detected peripheral device nodes, peripheral device capability data, peripheral device connectivity data, current peripheral device settings, peripheral device setting options, and current status of the peripheral devices at a peripheral device workspace. This allows the ecosystem manageability service module 568 to create a peripheral device workspace based on collection of this data at line 525 when a primary or anchor node information handling system 500 establishes connectivity within a set of nodes, such as a set of peripheral devices, in an identified location.

The ecosystem manageability service module 568 may continue to identify this created peripheral device workspace at line 530 with a unique peripheral device workspace identification value. The execution of the computer-readable program code of the ecosystem manageability service module 568 may further associate the identified peripheral device workspaces from the ecosystem manageability sub-agent 572 by associating a service tag and peripheral device workspace identification value to the created peripheral device workspace. In an embodiment, the association of a service tag and peripheral device workspace identification value for the created workspace may be stored on a database (not shown) associated with the peripheral device workspace cloud orchestrator server 558 as directed by the cloud manageability orchestrator module 566. Further, the cloud manageability orchestrator module 566 may also associate a peripheral device workspace identification value for a peripheral device workspace with a user in a composite peripheral device workspace identifier for one or more users in an enterprise as described in other embodiments herein.

At line 535, the cloud manageability orchestrator module 566 may conduct a search of associated data for any peripheral device found in a peripheral device workspace created at blocks 525 and 530 in a management database (not shown) associated with the one or more corresponding third-party manageability platforms 576 in an embodiment. This management database may include specific details about the enrolled peripheral devices from a particular third-party at line 505 and 510 as well as general information about the capabilities of the type of peripheral devices enrolled and potential settings associated with each of the enrolled peripheral devices. Each of the one or more third-party manageability platforms 576 may return this device-specific and general data for particular peripheral device nodes in created peripheral device workspaces having a peripheral device workspace identification value to the cloud manageability orchestrator module 566 at line 540.

At line 545, the cloud manageability orchestrator module 566 may be allowed to modify, such as by an ITDM or a user, any created peripheral device workspace created at blocks 525 and 530. For example, a user may have been associated with a specific peripheral device workspace such as a home office peripheral device workspace (e.g., 294, FIG. 2) in a composite peripheral device workspace identifier for that user that included an information handling system acting as the primary or anchor node device with a plurality of peripheral devices operatively coupled to the information handling system associated with that user and with that peripheral device workspace identification value for the peripheral device workspace. It may arise that an ITDM may order a new peripheral device for the user such as a wireless mouse with the new wireless mouse being operatively coupled to the information handling system in the peripheral device workspace having this particular peripheral device workspace identification value. In this example, the old mouse associated with the user's information handling system and indicated as being part of the created peripheral device workspace for this peripheral device workspace identification value may be removed from the workspace. Additionally, the new wireless mouse may be enrolled at line 510 and 505 and indicated as now forming part of the peripheral device workspace for this particular peripheral device workspace identification value and associated with the user under a composite peripheral device workspace identifier for the user. As such, the cloud manageability orchestrator module 566 may modify the created peripheral device workspace to not include the old mouse and replace it with the new wireless mouse with a new peripheral device identification such as a new serial number and other data (capabilities, connectivity, and other features) within the manifest of the peripheral device workspace. The ecosystem manageability service module 568 executed on the peripheral device workspace cloud orchestrator server 558 may record this modification of the particular peripheral device workspace having this particular peripheral device workspace identification value to indicate in the manifest of nodes that the new wireless mouse is now part of the peripheral device workspace and the old mouse is no longer to be included in the peripheral device workspace.

At line 550, the cloud manageability orchestrator module 566 may update a manifest and associated data at the peripheral device workspace based on the new wireless mouse peripheral device added and the old mouse removed. The device object is updated at the manageability database of the third-party manageability platform 576. At line 555, the third-party manageability platform 576 may indicate whether the update of the peripheral device workspace at the manageability database was successful or not.

It is appreciated as well that the ITDM may be able to access this created and modified peripheral device workspace by using the peripheral device workspace cloud orchestrator console 560 to access the peripheral device workspace from the cloud manageability orchestrator module 566 at line 561 to set enterprise hardware device operational policy, adjust performance or settings, provide for customized settings that are set or desired for a particular user who is associated with the peripheral device workspace identification value via a composite peripheral device workspace identifier for that user or for other management roles. In an embodiment, the created and modified peripheral device workspace including a manifest of nodes, capabilities, settings, or node status such as for updates or settings is rendered on a GUI presented to the ITDM at a video display device of the peripheral device workspace cloud orchestrator console 560 as described herein. Again, the ITDM may determine a number of potential issues associated with the modification of the peripheral device workspace including, but not limited to, whether the new wireless mouse is compliant or not with current hardware device operational policies provided by the ITDM at the third-party manageability platform 576, whether proper firmware/software updates have been received at or propagated to the newly added wireless mouse, and whether the wireless mouse is also forming or should be part of a different peripheral device workspace such as a hybrid work office peripheral device workspace. As such, the ITDM, via execution of the cloud manageability orchestrator module 566 on the peripheral device workspace cloud orchestrator server 558, can access this data in order to create and orchestrate one or more peripheral device workspaces.

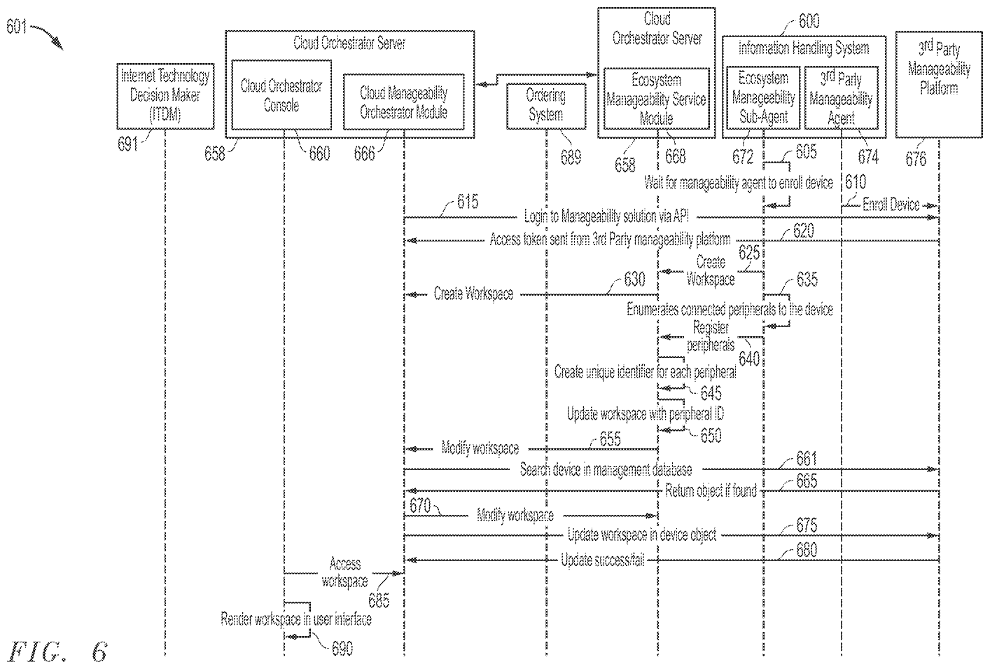

FIG. 6 is a flow chart showing a method 600 of executing code instructions of a cloud manageability orchestrator module 666 on a peripheral device workspace cloud orchestrator server 658 to automatically register node devices within one or more peripheral device workspaces to manage and orchestrate those node devices according to an embodiment of the present disclosure. FIG. 6 shows more details related to the execution of code instructions of a cloud manageability orchestrator module 666 for registering of those peripheral devices and information handling systems to the peripheral device workspaces having unique peripheral device workspace identification values and stored in a peripheral device workspace database accessible by the cloud manageability orchestrator module 766 in order to allow an ITDM to manage those peripheral device and information handling systems associated with one or more users.

In an embodiment, at line 605, the computer-readable program code of the ecosystem manageability sub-agent 672 is executed by a hardware processing device of the information handling system 600 in order to detect when a third-party manageability agent 674 executing on the information handling system 600 has enrolled a peripheral device or information handling system. This process of detecting when the third-party manageability agent 674 enrolls peripheral devices may be continuous in an embodiment. In another embodiment, the execution of the ecosystem manageability sub-agent 672 may periodically determine if and when the third-party manageability agent 674 has enrolled any peripheral devices as operational within a peripheral device workspace at line 610.

At line 615, the cloud manageability orchestrator module 666 may log into one or more third-party manageability platforms 676 via the API for corresponding peripheral devices as described in embodiments herein. In an embodiment, the third-party manageability platform 676 and cloud manageability orchestrator module 666 may work in concert to provide to the cloud manageability orchestrator module 666 any enrollment data and peripheral device ID data associated with any enrolled peripheral devices in a peripheral device workspace.

At line 620 an access token from the one or more third-party manageability platforms 676 may be provided to the cloud manageability orchestrator module 666. This access token allows the cloud manageability orchestrator module 666 to gain access to the peripheral device data for each enrolled peripheral device and information handling system from the one or more third-party manageability platforms.

At line 625, the ecosystem manageability sub-agent 672 may create a peripheral device workspace by identifying those peripheral devices and information handling systems that are operated by a specific user, a location where those peripheral devices and information handling systems are being operated, and the association of any peripheral devices to the information handling system as collected by the ecosystem manageability sub-agent 672. Such information may be used by the cloud manageability orchestrator module 666 executing at the peripheral device workspace cloud orchestrator server 658 for determination and identification of the peripheral device workspace with a peripheral device workspace identification value stored in a peripheral device workspace manifest at a peripheral device workspace database associated with the peripheral device workspace cloud orchestrator server 658. This allows the ecosystem manageability service module 568 to create a peripheral device workspace with the cloud manageability orchestrator module 666 at the peripheral device workspace cloud orchestrator server 658 based on this data at line 625.

The ecosystem manageability service module 668 may continue to identify this created peripheral device workspace at line 630 at the cloud manageability orchestrator module 666 with a unique peripheral device workspace identification value as described in embodiments herein. The execution of the computer-readable program code of the ecosystem manageability service module 668 may further associate the data for a manifest of nodes in the identified peripheral device workspaces from the ecosystem manageability sub-agent 672 by associating a service tag and peripheral device workspace identification value for each of the created peripheral device workspaces. In an embodiment, the association of a service tag and peripheral device workspace identification value to the created peripheral device workspace may be stored on a peripheral device workspace database (not shown) associated with the peripheral device workspace cloud orchestrator server 658 as directed by the cloud manageability orchestrator module 666.

At line 635, the ecosystem manageability sub-agent 672 may enumerate connected peripheral devices to the information handling system acting as the primary or anchor node device such as the information handling system 600 associated with the user. This enumeration of the connected peripheral devices may include the ecosystem manageability sub-agent 672 detecting which peripheral devices are operatively coupled to the information handling system 600, how those peripheral devices are operatively coupled to the information handling system 600, and an peripheral device identification (ID) associated with each of the connected peripheral devices in a manifest for the peripheral device workspace, among other identification data as well as a location for enumeration of peripheral devices and other nodes in a peripheral device workspace for association with a peripheral device workspace identification value. The peripheral device identification numbers, such as serial numbers, of peripheral devices in the manifest at a peripheral device workspace as well as a location value for a peripheral device workspace may be defined with a peripheral device workspace identification value by the cloud manageability orchestrator module 666 and stored in a peripheral device workspace database for reference by an ITDM of an enterprise as described in embodiments herein. Further, the peripheral device workspaces identified by peripheral device workspace identification values in the peripheral device workspace database may include data stored on the peripheral device workspace database and associated with each peripheral device workspace identification value. This data for each peripheral device workspace includes peripheral device identification identifiers unique to each peripheral device in the manifest of detected peripheral device nodes, peripheral device capability data, peripheral device connectivity data, current peripheral device settings, peripheral device setting options, and current status of the peripheral devices at a peripheral device workspace. Additionally, the enumeration of the connected peripheral devices may also include assigning a user to each of the connected peripheral devices for a peripheral device workspace identification value with a user composite peripheral device workspace identifier for a user associated with a primary or anchor node information handling system 600 such that those peripheral devices operatively coupled to the user's information handling system 600 are also tied to that user.

In an embodiment, the execution of the computer-readable program code of the ecosystem manageability sub-agent 672 may then register, at line 640, those enumerated peripheral device with the ecosystem manageability service module 668 in the peripheral device workspace associated with the particular peripheral device workspace identification value. This allows the ecosystem manageability service module 668 to determine the layout of each of the created peripheral device workspaces and, at line 645, create unique identifiers for each of the peripheral devices registered with a peripheral device workspace identification value from the ecosystem manageability sub-agent 672. This unique identifier for each of the peripheral devices may be a random number, a serial number, or the like and may be included in a manifest for a peripheral device workspace identification value as well as associated with the composite peripheral device workspace identifier associated with the user. Thus, the ecosystem manageability service module 668 may be capable of specifically identifying a specific peripheral device within a specific created peripheral device workspace having a peripheral device workspace identification value and that is associated with a specific user, among potentially plural peripheral device workspaces for the user, via a composite peripheral device workspace identifier for a user.

At line 650, the computer-readable program code of the ecosystem manageability service module 668 may be executed by the hardware processor of the peripheral device workspace cloud orchestrator server 658 to update a peripheral device workspace having a peripheral device workspace identification value to include each peripheral device. As described in other example embodiments herein, certain peripheral devices may be swapped out for other peripheral devices causing the workspace to change. For example, a user may operatively couple a secondary or tertiary external monitor to a docking station coupled to the information handling system 600. These new external monitors may be incorporated into the existing created peripheral device workspace with a particular peripheral device workspace identification value and the ecosystem manageability service module 668 may update that workspace as these new peripheral devices are discovered by the ecosystem manageability sub-agent 672.

This allows the ecosystem manageability service module 668 to, at line 655, provide this data to the cloud manageability orchestrator module 666 so that the modification of the peripheral device workspace created by the information handling system 600 and its peripheral devices in a manifest associated with the particular peripheral device workspace identification value may be updated at a database (not shown) associated with the peripheral device workspace cloud orchestrator server 658. These created, modified, and updated peripheral device workspaces having unique peripheral device workspace identification values may be saved on this database and may be associated with each user of each information handling system 600 in a composite peripheral device workspace identifier for a user having access within the plurality of created peripheral device workspaces.

At line 661, the cloud manageability orchestrator module 666 an IDTM or an automatic hardware device operational policy of an enterprise may search for the peripheral devices on a management database (not shown) associated with the third-party manageability platform 676 for peripheral devices associated with that third-party that are part of created or updated peripheral device workspace with a peripheral device workspace identification value. This management database may include specific details about the enrolled peripheral devices at line 605 and 610 as well as general information about the capabilities of the type of peripheral devices enrolled and potential settings associated with each of the enrolled peripheral devices. The third-party manageability platform 676 may return this device-specific and general data to the cloud manageability orchestrator module 666 at line 665 if found. For example, a user may have been associated with a specific peripheral device workspace in a composite peripheral device workspace identifier for the user identifying that peripheral device workspace identification value, such as a home office peripheral device workspace (e.g., 294, FIG. 2), the peripheral device workspace identification value may be stored with a peripheral device workspace manifest that includes an information handling system 600 acting as the primary or anchor node device with a plurality of peripheral devices operatively coupled to the information handling system 600 associated with that user. It may arise that an ITDM may order a new peripheral device for the user such as a wireless mouse with the new wireless mouse being operatively coupled to the information handling system at the peripheral device workspace of the particular peripheral device workspace identification value, such as of the home office peripheral device workspace. In this example, the old mouse associated with the user's information handling system and indicated as being part of the created workspace maybe removed from the particular peripheral device workspace, such as from the manifest of nodes of the peripheral device workspace identification value for the home office peripheral device workspace. As such, the cloud manageability orchestrator module 666 may modify the created peripheral device workspace for the peripheral device workspace identification value of the home office peripheral device workspace to not include the old mouse and replace it with the new wireless mouse that has the device-specific and general data associated with it. The ecosystem manageability service module 668 executed on the peripheral device workspace cloud orchestrator server 658 may record this modification of the peripheral device workspace manifest associated with the peripheral device workspace identification value for the home office peripheral device workspace to indicate the new wireless mouse and its device-specific and general data as being part of the home office peripheral device workspace and the old mouse is no longer to be included in the home office peripheral device workspace.

At line 675, the cloud manageability orchestrator module 666 may update the workspace based on the device-specific and general data added and indicated as being associated with each of the new peripheral devices in the workspace. The device object is updated at the management database of the third-party manageability platform 676 for the peripheral device identification so that any updates or functional modifications may be retrieved from the third-party manageability platform 676 for that peripheral device if such should occur and managed and controlled by the execution of the cloud manageability orchestrator module 666 at the peripheral device workspace cloud orchestrator server 658. At line 680, the third-party manageability platform 676 may indicate whether the update of the workspace at the management database was successful or not to the cloud manageability orchestrator module 666 executing at the peripheral device workspace cloud orchestrator server 658.

It is appreciated as well that the ITDM may be able to access this created and modified peripheral device workspace by using the peripheral device workspace cloud orchestrator console 660 to access the peripheral device workspace from the cloud manageability orchestrator module 666 at line 685. In an embodiment, the created and modified peripheral device workspace, such as the home office peripheral device workspace, is rendered with a manifest of peripheral device nodes identified, capabilities, connectivity options, and operational or update status as well as other peripheral device or node data on a GUI presented to the ITDM at a video display device of the peripheral device workspace cloud orchestrator console 660 as described herein. Again, the ITDM may determine a number of potential issues associated with the modification of the workspace including, but not limited to, whether the new wireless mouse is compliant or not with current hardware device operational policies provided by the ITSM at the third-party manageability platform 676, whether proper firmware/software updates have been received at or propagated to the newly added wireless mouse, and whether the wireless mouse is also forming or should be part of a different workspace such as a hybrid work office peripheral device workspace. As such, the ITDM, via execution of the cloud manageability orchestrator module 666 on the peripheral device workspace cloud orchestrator server 658, can access this data for any of a plurality of peripheral device workspaces in order to create and orchestrate one or more peripheral device workspaces.

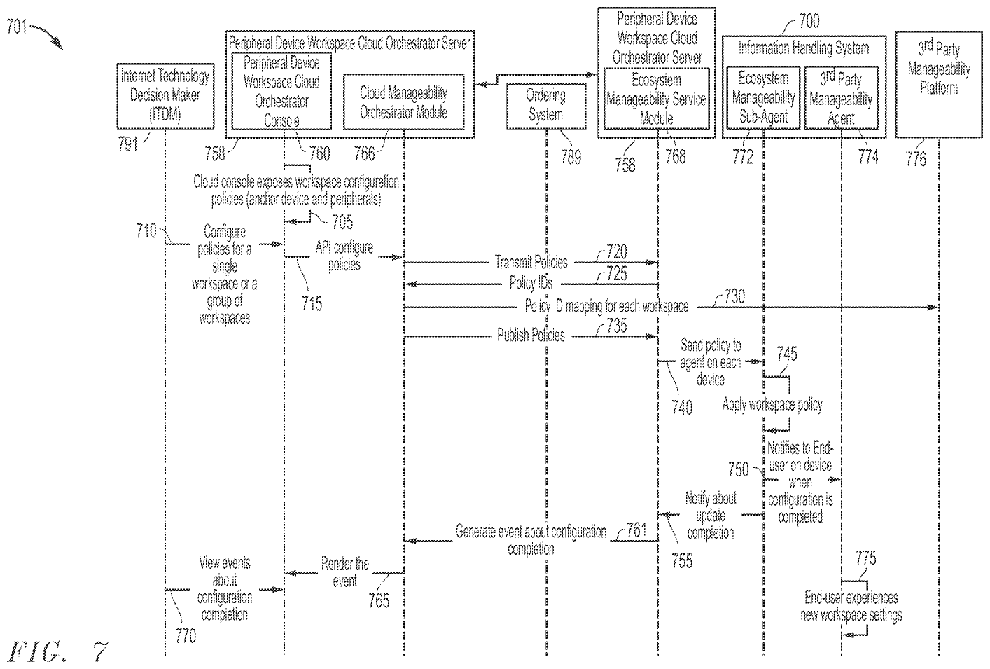

FIG. 7 is a flow chart showing a method 701 of executing code instructions of a cloud manageability orchestrator module 766 on a peripheral device workspace cloud orchestrator server 758 to automatically configure one or more peripheral device workspaces according to an embodiment of the present disclosure. FIG. 7 shows a method 701 of an ITDM using the cloud manageability orchestrator console 760 with the cloud manageability orchestrator module 766 to create hardware device operational policies that are applied to each type and individual peripheral device within any peripheral device workspace having a unique peripheral device workspace identification value and stored in a database accessible by the cloud manageability orchestrator module 766.

At line 705, the peripheral device workspace cloud orchestrator console 760 may expose the workspace configuration hardware device operational policies that are associated with the primary or anchor node device and the peripheral device nodes as processed by the third-party manageability agent 774, the ecosystem manageability sub-agent 772, and the ecosystem manageability service module 768 as described herein. The peripheral device workspace cloud orchestrator console 760 exposes these workspace configurations via a GUI presented on a video display device of the peripheral device workspace cloud orchestrator console 760 executing from the peripheral device workspace orchestrator server 758.

At line 710, the ITDM 791 may generate hardware device operational policies for a one or more peripheral devices or other device nodes within a peripheral device workspace or a group of peripheral device workspaces by engaging with the GUI presented to the user on the video display device of the peripheral device workspace cloud orchestrator console 760. For example, the ITDM may create hardware device operational policies that prevent certain peripheral devices or the primary or anchor node device (e.g., information handling system 700) from accessing data over a network that is not authorized by the ITDM 791 acting on behalf of the enterprise the ITDM 791. In an embodiment, the ITDM may be responsible for monitoring and controlling network resources as well as peripheral device and hardware systems. As such, the hardware device operational policies may be generated by the ITDM to prevent such unauthorized access to a network by any node device in one embodiment. In another embodiment, the hardware device operational policies generated by the ITDM may include hardware device operational policies that require key performance indicators (KPIs) to be met in order to remain within the peripheral device workspace or be included within the peripheral device workspace initially. These KPIs may include threshold battery power levels, threshold temperature levels, and threshold available processing resources among other KPIs.

In another embodiment, the hardware device operational policies generated by the ITDM to be propagated down to the individual peripheral device nodes may include policies that prevent certain users from being part of the peripheral device workspace or portions of the peripheral device workspace. For example, where the workspace is a conference room workspace, the hardware device operational policies may require that only certain information handling systems associated with certain users may form part of the conference room peripheral device workspace and utilize particular peripheral device nodes in order to prevent unauthorized users from being able to participate in videoconferencing sessions even if operatively coupled to, for example, a docking station within the conference room peripheral device workspace. In another example embodiment, the ITDM may generate a hardware device operational policy that prevents non-compliant peripheral devices from being included within a workspace. A non-compliant peripheral device may be those peripheral devices that subject the enterprise to security attacks, including unapproved software or firmware, and are capable of extracting secured data from the enterprise via the anchor node, and the like. Still further, the hardware device operational policies may include hardware device operational policies that prevent the inclusion of device nodes that have not had security firmware and/or software updated. Even further, the hardware device operational policies may include policies generated by the ITDM that configure auto pairing of peripheral devices in a multi-user scenario based on work schedules of the users of the primary or anchor node devices thereby enabling immediate and secure connectivity to a particular user of the primary or anchor node, the peripheral device workspace and associated peripheral devices.

In the context of the present specification, therefore, the hardware device operational policies may include any ITDM-generated policies that control how each of the device nodes (e.g., anchor nodes and peripheral devices) are to be included within a peripheral device workspace, whether they remain compliant or not within the workspace, and how each device node is allowed to operate within the workspace. It is appreciated that any hardware device operational policies may be created by the ITDM 791 and applied to any of the peripheral devices and information handling systems 700 that fit a specific agenda on behalf of the enterprise, for example, and the present specification contemplates the implementation of these other hardware device operational policies to be applied to individual nodes within the created peripheral device workspaces.

At line 715, the peripheral device workspace cloud orchestrator console 760 may configure these hardware device operational policies as edited by the ITDM 791 via an API and pass those hardware device operational policies onto the cloud manageability orchestrator module 766 at the peripheral device workspace cloud orchestrator server 758. Thus, the peripheral device workspace cloud orchestrator console 760 acts as a single location where the ITDM 791 can initiate the propagation of the hardware device operational policies through to all peripheral devices and information handling systems 700 in one or more peripheral device workspaces managed by the ITDM 791. The cloud manageability orchestrator module 766 automatically propagates these developed hardware device operational policies as necessary based on the types of peripheral devices detected within each of the peripheral device workspaces with the API and managed with the cloud manageability orchestrator module 766 at the peripheral device workspace cloud orchestrator server 758.

At line 720, the cloud manageability orchestrator module 766 may transmit these hardware device operational policies to the ecosystem manageability service module 768 for distribution on to each device node at block 740 via communication with the ecosystem manageability sub-agent 772 on the primary or anchor information handling system device node in any give peripheral device workspace. This is done so that the hardware device operational policies created by the ITDM 791 and configured at the cloud manageability orchestrator module 766 can be assigned a policy ID at line 725. The policy ID may be used to specifically identify the hardware device operational policies being applied to the peripheral devices and to one or more peripheral device workspaces. In an embodiment, these hardware device operational policies and their associated policy IDs may be returned to the cloud manageability orchestrator module 766 to be stored on a database associated with the peripheral device workspace cloud orchestrator server 758 for later use or modification by the ITDM 791 if necessary. Further, the policy IDs may be associated in the database with peripheral device workspace identification values for various peripheral device workspaces to which these hardware device operational policies have been applied.

At line 730, the cloud manageability orchestrator module 766 may map the policy IDs for each of the peripheral device workspaces in the database as described. This may be done by execution of the cloud manageability orchestrator module 766 at the peripheral device workspace cloud orchestrator server 758. This policy ID mapping is then shared with the one or more third-party manageability platforms 776 such that the policy IDs mapped to each of the peripheral devices detected earlier by the third-party manageability agent 774 as described herein. The hardware device operational policy changes and status of the peripheral devices are shared with the one or more third-party manageability platforms 776 at a remote third-party servers that may also support one or more different types of peripheral devices.

At line 735, the hardware device operational policies created by the ITDM 791 may be published to the ecosystem manageability service module 768. The ecosystem manageability service module 768, knowing the layout of each peripheral device workspace as well as the peripheral devices and information handling systems 700 within each created peripheral device workspaces, may determine which of the peripheral devices and information handling systems 700 are to receive the hardware device operational policies. At line 740, the ecosystem manageability service module 768 may then send the hardware device operational policies to each of the peripheral devices in any particular peripheral device workspace if necessary, via an eco-system manageability sub-agent 772 executing on a primary or anchor node for the peripheral device workspace such as information handling system 700. Again, these hardware device operational policies may include any ITDM-generated policies that control how each of the device nodes (e.g., anchor nodes and peripheral devices) are to be included within a peripheral device workspace, whether they remain compliant or not within the workspace, and how each device node is allowed to operate within the workspaces. Where a hardware device operational policy does not apply to a specific peripheral device or an information handling system 700, due to the mapping process at line 730, the ecosystem manageability service module 768 may not send the hardware device operational policies to those non-affected devices. However, where the hardware device operational policies do apply to any given peripheral device or information handling system 700 in a particular peripheral device workspace, the ecosystem manageability service module 768 sends these hardware device operational policies onto the ecosystem manageability sub-agent 772 executing on a hardware processor of any primary or anchor node such as information handling system 700 for transmission to any affected peripheral device within the peripheral device workspace.

At line 745, each of the ecosystem manageability sub-agents 772 executing on the primary or anchor node such as information handling systems 700 and applies the workspace hardware device operational policies as created by the ITDM 791 on the primary or anchor node if applicable or at each of the affected peripheral devices in the peripheral device workspace operatively coupled to the primary or anchor node. Further to the examples presented herein, the hardware device operational policies may include, for example, a policy generated by an ITDM that prevents certain types of peripheral devices from being included within a workspace such that the anchor node device is not allowed to be operatively coupled to these types of peripheral devices. This may be because the hardware device operational policies have indicated that these peripheral devices are non-compliant due to, for example, potential security issues. As such, the systems and methods described herein, allow a ITDM 791 to write a hardware device operational policy once and define any peripheral device that is to have the hardware device operational policy applied to it in any given peripheral device workspace. At this point, a user may be notified that the hardware device operational policies have been applied to their peripheral devices and information handling system 700 via, for example, a notification presented to the user on a video display device of the information handling system 700 at line 750. Further the user of the information handling system 700 may experience the new or modified workspace settings applied via the hardware device operational policies transmitted to the peripheral device workspace where the end-user is located at block 775.

Returning to line 755, notification of the updating of the hardware device operational policies may be passed from each ecosystem manageability sub-agent 772 to the ecosystem manageability service module 768 executing on the peripheral device workspace cloud orchestrator server 758. An event may be generated indicating that the configuration has been completed at line 761 thereby allowing the ecosystem manageability service module 768 to notify the cloud manageability orchestrator module 766 of the completion of this task.

At line 765, the outcome of the configuration event is rendered on a GUI presented to the ITDM 791 on a video display device of the peripheral device workspace cloud orchestrator console 760. This allows the ITDM 791 to know if and when the hardware device operational policies are applied, how many peripheral devices have had the hardware device operational policies applied to them, and whether there are any pending hardware device operational policy applications still pending for any other peripheral devices or information handling systems 700 within any given workspace. The ITDM 791 may be allowed to view these hardware device operational policy update events at line 770. Still further, the user of the information handling system 700 may use the peripheral devices and information handling systems 700 with the new workspace settings as indicated by the newly applied hardware device operational policies. At this point the method may end.

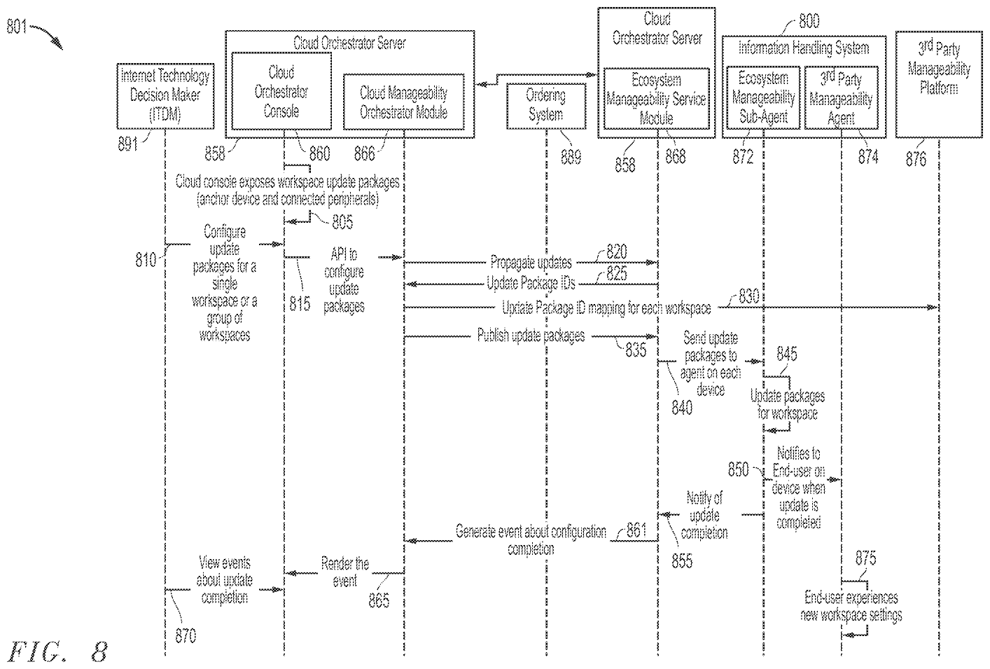

FIG. 8 is a flow chart showing method 801 of executing code instructions of a cloud manageability orchestrator module 866 on a peripheral device workspace cloud orchestrator server 858 to automatically update one or more peripheral device workspaces by propagating update packages to the node devices within the peripheral device workspace according to an embodiment of the present disclosure. FIG. 8 shows a method 801 of an ITDM using a peripheral device workspace cloud console 860 of the on a peripheral device workspace cloud orchestrator server 858 to create update packages that are to be applied to each type and individual peripheral device within any peripheral device workspace having a unique peripheral device workspace identification value as recorded and accessed by the cloud manageability orchestrator module 866. These update packages may include firmware/software updates for each type of peripheral device and information handling system 800.

At line 805, the peripheral device workspace cloud orchestrator console 860 may expose the workspace update packages that are to be applied to the primary or anchor node device and the peripheral devices as processed by the third-party manageability agent 874, the ecosystem manageability sub-agent 872, and the ecosystem manageability service module 868 as described herein. The peripheral device workspace cloud orchestrator console 860 exposes these workspace update packages via a GUI presented on a video display device of the peripheral device workspace cloud orchestrator console 860.

At line 810, the ITDM 891 may configure update packages for a single workspace or a group of workspaces by engaging with the GUI presented to the user on the video display device of the peripheral device workspace cloud orchestrator console 860. For example, the ITDM may identify update packages that are to be applied to certain peripheral devices or the primary or anchor node devices (e.g., information handling system 800) that are to be applied in order to prevent, for example, increase security associated with the operation of the peripheral devices or information handling systems 800 as well as proactively remediate issues with devices associated with the peripheral devices during operation. These update packages may include, for example, firmware/software packages that update functions of peripheral devices, update communication protocols between the anchor nodes and peripheral devices, as well as update hardware operations of the anchor nodes and/or peripheral devices. It is appreciated that that any update packages may be identified and configured by the ITDM 891 and applied to any of the peripheral devices and information handling systems 800 such that firmware/software for each of the anchor nodes and peripheral devices within each peripheral device workspace is up to date.

At line 815, the peripheral device workspace cloud orchestrator console 860 may configure these update packages as identified by the ITDM 891 via an API and pass those update packages onto the cloud manageability orchestrator module 866. Thus, the peripheral device workspace cloud orchestrator console 860 acts as a single location where the ITDM 891 can initiate the propagation of the update packages through all peripheral devices and information handling systems 800 and allow the cloud manageability orchestrator module 866 to automatically propagate these update packages as necessary based on the types of peripheral devices detected within each of the peripheral device workspaces.

At line 820, the cloud manageability orchestrator module 866 may transmit these update packages to the ecosystem manageability service module 868. This is done so that the update packages identified by the ITDM 891 and configured at the cloud manageability orchestrator module 866 can be assigned an update package ID at line 825. The update package ID may be used to specifically identify the update packages being applied to the peripheral devices and/or information handling system 800 in one or more peripheral device workspaces and also provided with data associated with the status of peripheral devices in a peripheral device workspace as associated with its peripheral device workspace identification value in the database associated with the peripheral device workspace cloud orchestrator server. In an embodiment, these update packages and their associated update package IDs may be stored on the database associated with the peripheral device workspace cloud orchestrator server 858 for later use or modification by the ITDM 891 if necessary as well as linked to the data on status or peripheral device or other nodes in particular peripheral device workspaces with peripheral device workspace identification values. These update package IDs may be returned to the cloud manageability orchestrator module 866.

At line 830, the cloud manageability orchestrator module 866 may map the update package IDs for each of the peripheral device workspaces according to its peripheral device workspace identification value in the database of the peripheral device workspace cloud orchestrator server 858 as described above. This may be done at the cloud manageability orchestrator module 866. This mapping of the update package IDs for peripheral device workspaces and the peripheral devices therein may be transmitted to one or more third-party manageability platforms 876 to provide the maps of the update package IDs to each of the third-party manageability platforms 876 that support the peripheral devices detected earlier by the third-party manageability agent 874 as operating in a given peripheral device workspace as described in embodiments herein.

At line 835, the update packages identified and configured by the ITDM 891 may be published to the ecosystem manageability service module 868 in the peripheral device workspace cloud orchestrator server 858. The ecosystem manageability service module 868, having access to the layout of each workspace as well as the peripheral devices and information handling systems 800 within each created peripheral device workspace based on its peripheral device workspace identification value may determine which of the peripheral devices and information handling systems 800 are to receive particular update packages. At line 840, the ecosystem manageability service module 868 may send the update packages to each of the peripheral devices, if necessary, via the ecosystem manageability sub-agent 872 executing on a primary or anchor node of the peripheral device workspace, such as information handling system 800. Where an update package does not apply to a specific peripheral device or an information handling system 800, due to the mapping process at line 830, the ecosystem manageability service module 868 may not send the update packages to those peripheral devices via the ecosystem manageability sub-agent 872. However, where the update packages do apply to any given peripheral device or primary or anchor node such as information handling system 800, the ecosystem manageability service module 868 sends these update packages onto the ecosystem manageability sub-agent 872 executing on a hardware processor of the primary or anchor node such as information handling system 800 and then onto any affected peripheral device operatively coupled to the primary or anchor node, such as information handling system 800 within the peripheral device workspace.

At line 845, each of the ecosystem manageability sub-agents 872 on each of the affected peripheral devices and information handling systems 800 applies the update packages as identified and configured by the ITDM 891 to the relevant peripheral device node or other device in the peripheral device workspace as mapped. As such, the systems and methods described herein, allow an ITDM 891 to identify and configure update packages once and define any peripheral device that is to have the update packages applied to it in any given peripheral device workspace. At this point, a user may be notified that the update packages have been applied to their peripheral devices and information handling system 800 via, for example, a notification presented to the user on a video display device of the information handling system 800 at line 850. The end-user may experience any updates to the peripheral device workspace after installation as relevant at block 875.

At line 855 notification of the propagation of the update packages may be passed from each ecosystem manageability sub-agent 872 to the ecosystem manageability service module 868 executing on the peripheral device workspace cloud orchestrator server 858. An event may be generated indicating that the configuration has been completed at line 861 thereby allowing the ecosystem manageability service module 868 to notify the cloud manageability orchestrator module 866 of the completion of this task.

At line 865, the outcome of the configuration event is rendered on a GUI presented to the ITDM 891 on a video display device of the peripheral device workspace cloud orchestrator console 860. This allows the ITDM 891 to know if and when the update packages are applied, how many peripheral devices have had the update packages applied to them, and whether there are any pending update package applications still pending for any other peripheral devices or information handling systems 800 within any given workspace. The ITDM 891 may be allowed to view these update events at line 870. Still further, the user of the information handling system 800 may use the peripheral devices and information handling systems 800 with the new workspace settings as indicated by the newly applied update packages.

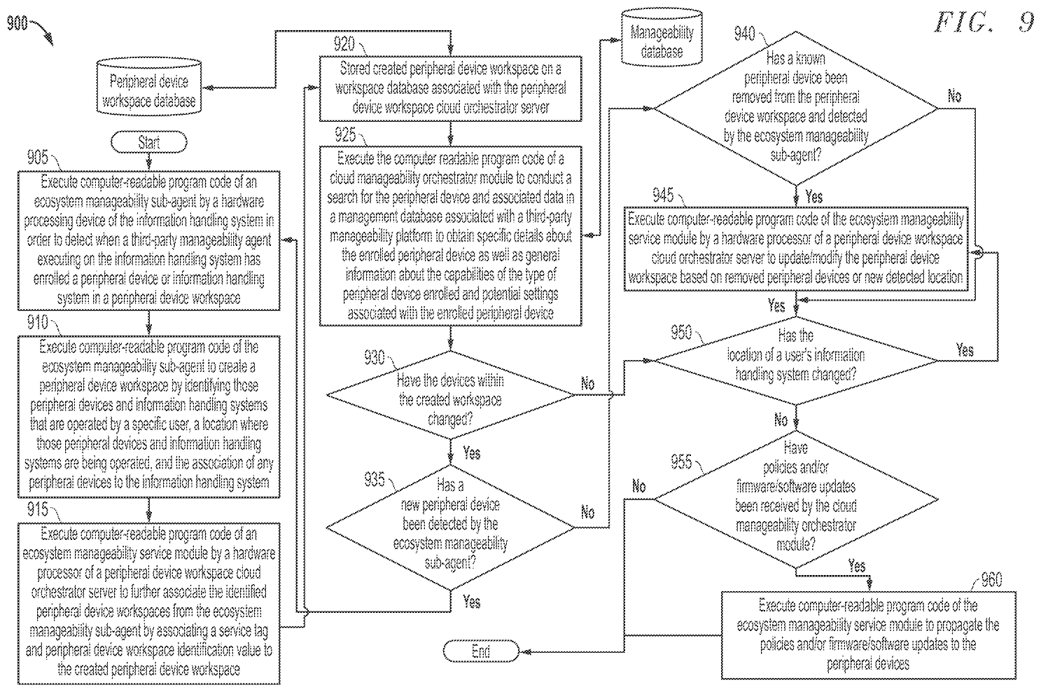

FIG. 9 is a flow chart showing method 900 of executing code instructions for a cloud manageability orchestrator module at a peripheral device workspace cloud orchestrator server automatically creating a peripheral device workspaces, updating a peripheral device workspaces, and propagating update packages to the node devices within the peripheral device workspaces according to an embodiment of the present disclosure. The method 900 described in FIG. 9 may include one or more processes described in connection with FIGS. 4-8 in an embodiment.

The method 900 may include, at block 905, executing computer-readable program code of an ecosystem manageability sub-agent by a hardware processing device of the information handling system 500 in order to detect when a third-party manageability agent executing on the information handling system has enrolled a peripheral device or information handling system as operating within a peripheral device workspace. This process of detecting when the third-party manageability agent enrolls peripheral devices may be continuous in an embodiment. In another embodiment, the execution of the ecosystem manageability sub-agent may periodically determine if and when the third-party manageability agent has enrolled any peripheral devices at line 510 as operating with the peripheral device workspace.

At block 910, the computer-readable program code of the ecosystem manageability sub-agent is executed by the hardware process of the user's information handling system serving as the anchor node to create a workspace by identifying those peripheral devices and information handling systems that are operated by a specific user, a location where those peripheral devices and information handling systems are being operated, and the association of any peripheral devices to the information handling system. As described herein, a peripheral device workspace may include a primary or anchor node that is operatively coupled to one or more peripheral devices, the peripheral device workspace may be operated by a user and may be associated with that user. For example, execution of the computer-readable program code of the ecosystem manageability sub-agent may identify the user, identify the plurality of peripheral devices, identify the anchor node such as the user's information handling system, as well as current settings, potential settings, capabilities, and other features of both the detected peripheral devices and the anchor node.

The method 900 may also include executing computer readable program code of an ecosystem manageability service module by a hardware processor of a peripheral device workspace cloud orchestrator server to further associate the identified peripheral device workspaces from the ecosystem manageability sub-agent by associating a service tag and peripheral device workspace identification value to the created peripheral device workspace at block 915. As described herein, the created peripheral device workspace may be associated with a unique peripheral device workspace identification value when stored with a manifest of peripheral device nodes with peripheral device identification in the peripheral device workspace, location identifier, and data for the peripheral device workspace that specifically identifies the created peripheral device workspace and its associated peripheral devices, nodes, capabilities, settings, and potential settings of those node devices within the created peripheral device workspace. This peripheral device workspace with identifying or descriptive data and associated peripheral device workspace identification value is stored at a peripheral device workspace database for reference during management by a peripheral device workspace cloud orchestrator server executing code instructions of a cloud manageability orchestrator module among other software management modules. It is appreciated that that any number of peripheral device workspaces may be created, and any number of peripheral device workspaces may be associated with any given user via a user composite peripheral device workspace identifier as described in connection with FIG. 2 and other embodiments herein.

At block 920, the created workspaces are stored on a peripheral device workspace database associated with the peripheral device workspace cloud orchestrator server. Again, the workspace database may store the created and identified peripheral device workspaces such that they are associated with a peripheral device workspace identification value. Additionally, a unique identifier for each peripheral device node discovered by the execution of the computer-readable program code of the ecosystem manageability sub-agent previously at the information handling system is associated with a peripheral device workspace identification value. The execution of the ecosystem manageability service module may also have caused a peripheral device workspace to be updated with the identification of each of the peripheral devices and device nodes within the peripheral device workspace at that location and associated with the peripheral device workspace identification value and this data may be updated based on the peripheral device workspace identification value associated with the created peripheral device workspace. In an embodiment, the peripheral device workspace identification value may be associated with a user associated with each peripheral device workspace via a composite peripheral device workspace identifier for a user identifying peripheral device workspaces for that user. An ITDM may be appraised of this data at a peripheral device workspace cloud orchestrator console which may display this data to the ITDM on, for example, a cloud orchestrator video display device. This allows the ITDM to interface with those GUIs presented on the cloud orchestrator video display device and interact with and make changes to the created peripheral device workspaces if/when necessary.

At block 925, computer-readable program code of a cloud manageability orchestrator module is executed by a hardware processor of the peripheral device workspace cloud orchestrator server to conduct a search for the peripheral device and associated data in a management database associated with a third-party manageability platform. This search may be done to obtain specific details about the enrolled peripheral device within each of the created peripheral device workspaces as well as general information about the capabilities of the type of peripheral devices enrolled and potential settings associated with the enrolled peripheral device. In an embodiment, the manageability database may be associated with a third-party manageability platform that may provide potential settings, configurations, and characteristics of each peripheral device node and anchor node (e.g., user's information handling system) of each peripheral device workspace saved at the workspace database.

As described herein, the execution of the ecosystem manageability sub-agent, ecosystem manageability service module, and cloud manageability orchestrator module by their respective hardware processors may be used to detect when any given created workspace has changed based on, for example, the inclusion of a new peripheral device, the swapping out of peripheral devices or anchor nodes such as the user's information handling system, and the removal of a peripheral device within the created peripheral device workspace. At block 930, the execution of the ecosystem manageability sub-agent, and the ecosystem manageability service module may determine whether the created workspace has changed with regard to the nodes within the peripheral device workspace. Where no change is detected, the method 900 proceeds to block 950 as described herein.

Where a change is detected, the execution of the ecosystem manageability sub-agent and ecosystem manageability service module, it may be determined whether the change was due to a detection of an inclusion of a new peripheral device to the created peripheral device workspace at block 935 and/or the removal of a peripheral device from within the created peripheral device workspace at block 940. For example, at block 935, where a new peripheral device has been detected as being operatively coupled to the primary or anchor node information handling system, the method 900 may continue to block 905 as described herein in order to identify that new peripheral device, the settings of the new peripheral device, configurations of the new peripheral device, characteristics of the new peripheral device, and the like in order to later update the nodes within the created peripheral device workspace. It is appreciated that the detection of the new peripheral device by the ecosystem manageability sub-agent and ecosystem manageability service module may include a detection of a new wired or wireless connection between the anchor node (e.g., a docking station or an information handling system) with the ecosystem manageability sub-agent being notified of the new peripheral device by the hardware processor of the user's information handling system.

Where no new peripheral device has been detected at block 935, but the execution of the ecosystem manageability sub-agent and ecosystem manageability service module does detect that a known peripheral device has been removed from the peripheral device workspace at block 940, the method 900 continues to block 950 as described herein. However, where the execution of the ecosystem manageability sub-agent by the hardware processor of the anchor node detects a removal of a peripheral device from the peripheral device workspace (e.g., operatively uncoupling the peripheral device from the anchor node), the method 900 continues to block 945. At block 945, the computer-readable program code of the ecosystem manageability service module updates and modifies the peripheral device workspace based on the removed peripheral device. This includes the ecosystem manageability service module editing the stored workspace data on the workspace database to show that the removed peripheral device. This includes, at least, the removal of the node data associated with this removed peripheral device.

At block 950, the method 900 includes determining, with the execution of the ecosystem manageability sub-agent on the user's anchor node (e.g. information handling system) whether the location of the information handling system changed. As described herein, data defining the location of the anchor node or the user's information handling system may help to define the peripheral device workspace as described in FIG. 2, for example. In an example embodiment, a user may move the information handling system from one location to another such that a peripheral device workspace is created (e.g., at block 910) for each location such as a home office, a work office, a living room, and a conference room to name a few examples. It is appreciated that each of the created peripheral device workspaces (e.g., home office peripheral device workspace, living peripheral device workspace, hybrid work office peripheral device workspace, and conference room peripheral device workspace) may include different peripheral device nodes and are physically located at different locations. Thus, although a docking station node device may be included within a hybrid work office peripheral device workspace and a home office peripheral device workspace, each docking station is a different peripheral device node at a different location. In an embodiment, the execution of the ecosystem manageability sub-agent may be provided with geolocation data, network data, and the like that allows the ecosystem manageability sub-agent to determine the physical location of the anchor node at any give time. This location data may be provided to the ecosystem manageability sub-agent via the hardware processor of the anchor node in an embodiment. In a specific example, the access point to which the anchor node is operatively coupled to in order to gain access to a network may define the physical location of the anchor node. This may be true even where, at a worksite, the user moves the anchor node from a hybrid work office peripheral device workspace to a conference room peripheral device workspace located within the same office building. Still further, in an embodiment, online geolocation data obtained from, for example, Google® Maps®, Apple® Maps®, and other web mapping platforms may be used to determine the location of the anchor node. Where, at block 950, the location of the anchor node has not changed the method 900 moves onto block 945. However, where the execution of the ecosystem manageability sub-agent determines that the location of the anchor node has changed, the method returns to block 945 with the workspace being updated based on the new detected location.

At block 945, the execution of the ecosystem manageability service module may monitor for and determine whether hardware device operational policies and/or firmware/software updates been received by the cloud manageability orchestrator module. Where these hardware device operational policies and/or firmware/software updates have not been received, the method 900 may end here with the workspaces having been created and all available hardware device operational policies and/or firmware/software updates being propagated down to the appropriate node devices via identification within the workspace database of these node devices being part of any given workspace. Where these hardware device operational policies and/or firmware/software updates have been received, the execution of the cloud manageability orchestrator module may result in the identification of affected device nodes within affected workspaces at the workspace database. Having identified the affected workspaces by peripheral device workspace identification values, the execution of the ecosystem manageability service module may cause these hardware device operational policies and/or firmware/software updates to be propagated down to the proper node devices while not passing the hardware device operational policies and/or firmware/software updates to unaffected node devices and peripheral device workspaces. Having propagated these hardware device operational policies and/or firmware/software updates and creating workspaces, among other tasks, the method 900 may end.

The blocks of the flow diagrams of FIGS. 4-9 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A peripheral device workspace cloud orchestrator server, comprising:
a hardware processor;
a memory device;
a power management unit (PMU) to provide power to the hardware processor and memory device;
a network interface device to receive detected peripheral device enrollment data describing peripheral device nodes to be registered with the peripheral device workspace cloud orchestrator server and receive hardware device operational policies describing how the registered peripheral device nodes are to operate;
the hardware processor to execute computer code of a cloud manageability orchestrator module to create and store, on a peripheral device workspace database, peripheral device workspaces with each of the peripheral device workspaces having a peripheral device workspace identification value, wherein the peripheral device workspaces are defined by a manifest of detected peripheral device nodes operatively coupled to an anchor node information handling system and a physical location of the detected peripheral device nodes; and
the hardware processor to execute computer code of an ecosystem manageability service module to apply the hardware device operational policies to appropriate peripheral device nodes within the created peripheral device workspaces based on identification of the peripheral device workspace identification values identifying peripheral device nodes in the peripheral device workspace.

2. The peripheral device workspace cloud orchestrator server of claim 1 further comprising:
a peripheral device workspace cloud orchestrator console operatively coupled to the cloud orchestrator server to receive input from an internet technology decision maker (ITDM) to review the node device enrollment data describing one or more peripheral device nodes of a first peripheral device workspace with a first peripheral device workspace identification value and to create the hardware device operational policies that define the first peripheral device workspace with the one or more peripheral device nodes forming part of the first peripheral device workspace.

3. The peripheral device workspace cloud orchestrator server of claim 1, wherein peripheral device nodes purchased by an ITDM have hardware device operational policies applied to them based on purchasing data associated with the one or more peripheral device nodes and associated with a user of the purchased peripheral node devices for a first peripheral device workspace with a first peripheral device workspace identification value.

4. The peripheral device workspace cloud orchestrator server of claim 1, wherein execution of the cloud manageability orchestrator module causes peripheral device nodes identified in a plurality of the peripheral device workspaces having peripheral device workspace identification values indicating the peripheral device nodes are located there to receive firmware and software updates.

5. The peripheral device workspace cloud orchestrator server of claim 1 further comprising:
a peripheral device workspace cloud orchestrator console operatively coupled to the cloud orchestrator server to receive input from an ITDM to detect each of the peripheral device nodes in a first peripheral device workspace as being compliant or non-compliant of the hardware device operational policies applied by the ecosystem manageability service module.

6. The peripheral device workspace cloud orchestrator server of claim 1 further comprising:
the hardware processor to execute computer code of a cloud manageability orchestrator module to link a plurality of the peripheral device workspace identification values with a user composite peripheral device workspace identifier that identifies a user of an anchor node information handling system within a plurality of the peripheral device workspaces identified with the plurality of the peripheral device workspace identification values.

7. The peripheral device workspace cloud orchestrator server of claim 1, wherein the hardware processor receives the device enrollment data from an anchor node information handling including a hardware processor executing an ecosystem manageability sub-agent that gathers the device enrollment data from the peripheral device nodes forming part of each of the peripheral device workspaces.

8. The peripheral device workspace cloud orchestrator server of claim 1, wherein data stored on the peripheral device workspace database and associated with each peripheral device workspace identification value includes peripheral device identification identifiers unique to each peripheral device in the manifest of detected peripheral device nodes in a corresponding peripheral device workspace, peripheral device capability data, peripheral device connectivity data, current peripheral device settings, peripheral device setting options, and current status of the peripheral device.

9. A method of creating and orchestrating a peripheral device workspace comprising:
executing code instructions of a cloud manageability orchestrator module with a hardware processor of a peripheral device workspace cloud orchestrator server to receive peripheral device enrollment data describing peripheral device nodes and create a peripheral device workspace having a peripheral device workspace identification value with the peripheral device nodes forming part of the peripheral device workspace;
storing the peripheral device workspace identification value and descriptive data for the peripheral device workspace at a peripheral device workspace database;
receiving hardware device operational policies from a cloud peripheral device workspace orchestrator console operatively coupled to the cloud peripheral device workspace orchestrator server and operated by an internet technology decision maker (ITDM) based on the registered peripheral device nodes detected within the created peripheral device workspace; and
executing computer code of an ecosystem manageability service module, via the peripheral device workspace cloud orchestrator server, to apply the hardware device operational policies to the created peripheral device workspace via an anchor node information handling system operatively coupled in the peripheral device workspace, wherein the cloud manageability orchestrator module creates hardware device operational policies for each of the peripheral device nodes within the peripheral device workspace based on identification of the peripheral device workspace identification value having an identified peripheral device node in a manifest of peripheral devices for the peripheral device workspace that is subject to the hardware device operational policies.

10. The method of claim 9 further comprising:
a peripheral device workspace cloud orchestrator console operatively coupled to the cloud orchestrator server to receive input from the ITDM to review the node device enrollment data describing one or more peripheral device nodes on the manifest of the peripheral device workspace and to create the hardware device operational policies that define the peripheral device workspace with the one or more peripheral device nodes forming part of the peripheral device workspace identified by the peripheral device workspace identification value.

11. The method of claim 9, wherein one or more peripheral device nodes purchased by the ITDM have hardware device operational policies applied to them based on purchasing data associated with the one or more peripheral device nodes and associated with a user of the purchased peripheral node devices for the peripheral device workspace with the peripheral device workspace identification value.

12. The method of claim 9, wherein execution of the cloud manageability orchestrator module causes peripheral device nodes identified in the manifest of the peripheral device workspace having the peripheral device workspace identification value to receive firmware and software updates.

13. The method of claim 9 further comprising:
detecting at the cloud orchestrator server whether each of the peripheral device nodes is being compliant or non-compliant of the hardware device operational policies applied by the ecosystem manageability service module; and
displaying whether each of the peripheral device nodes is being compliant or non-compliant on a peripheral device workspace cloud orchestrator console operatively coupled to the cloud orchestrator server to the ITDM.

14. The method of claim 9 further comprising:
executing computer code of a cloud manageability orchestrator module, via the hardware processor, to link the peripheral device workspace identification value with a user composite peripheral device workspace identifier that identifies a user of an anchor node information handling system within the peripheral device workspace identified with the peripheral device workspace identification value.

15. The method of claim 9, wherein the hardware processor receives the device enrollment data from an anchor node information handling including a hardware processor executing an ecosystem manageability sub-agent that gathers the device enrollment data from the peripheral device nodes forming part of the peripheral device workspace.

16. A peripheral device workspace cloud orchestrator server, comprising:
a hardware processor;
a memory device;
a power management unit (PMU) to provide power to the hardware processor and memory device; and
a network interface device to receive detected peripheral device enrollment data describing peripheral device nodes to be registered with the peripheral device workspace cloud orchestrator server and to receive hardware device operational policies describing how the registered peripheral device nodes are to operate;
the hardware processor to execute computer code of a cloud manageability orchestrator module to create peripheral device workspaces with each of the peripheral device workspaces having a peripheral device workspace identification value, wherein the peripheral device workspaces are defined by a manifest of detected peripheral device nodes operatively coupled to an anchor node information handling system and a physical location of the anchor node information handling system;
a peripheral device workspace database to store each of the peripheral device workspaces having the peripheral device workspace identification values and data describing each peripheral device workspace including connectivity of each peripheral device to the anchor node information handling system in the created peripheral device workspace, capabilities of the peripheral device nodes, and current settings associated with each of the peripheral device nodes; and
the hardware processor to apply the hardware device operational policies to appropriate peripheral device nodes within the created peripheral device workspaces based on identification of the peripheral device workspace identification values identifying peripheral device nodes within the created peripheral device workspace.

17. The peripheral device workspace cloud orchestrator server of claim 16 further comprising:
a peripheral device workspace cloud orchestrator console operatively coupled to the cloud orchestrator server to receive input from an internet technology decision maker (ITDM) to review the node device enrollment data describing one or more peripheral device nodes of a first peripheral device workspace and to create the hardware device operational policies that define the first peripheral device workspace with the one or more peripheral device nodes forming part of the first peripheral device workspace.

18. The peripheral device workspace cloud orchestrator server of claim 16, wherein peripheral device nodes purchased by an ITDM for a first peripheral device workspace have hardware device operational policies applied to them based on purchasing data associated with the one or more peripheral device nodes and associated with a user of the purchased peripheral node devices for the first peripheral device workspace having a first peripheral device workspace identification value.

19. The peripheral device workspace cloud orchestrator server of claim 16, wherein execution of the cloud manageability orchestrator module causes peripheral device nodes identified in a plurality of peripheral device workspaces each having peripheral device workspace identification values to receive firmware and software updates.

20. The peripheral device workspace cloud orchestrator server of claim 16 further comprising:
the hardware processor to execute computer code of a cloud manageability orchestrator module to link a plurality of the peripheral device workspace identification values with a user composite peripheral device workspace identifier that identifies a user of an anchor node information handling system within a plurality of the peripheral device workspaces identified with the plurality of the peripheral device workspace identification values.
